(19) United States
(12) Patent Application Publication
(10) Pub. No.: US 2025/0132858 A1
(43) Pub. Date: Apr. 24, 2025

(54) PADDING FOR TRIGGER FRAME, BLOCK ACKNOWLEDGMENT REQUEST (BAR) AND BLOCK ACKNOWLEDGMENT (BA) PROTECTION

(71) Applicants: Po-Kai HUANG, San Jose, CA (US); Laurent CARIOU, Milizac (FR); Danny ALEXANDER, Neve Efraim Monoson (IL)

(72) Inventors: Po-Kai HUANG, San Jose, CA (US); Laurent CARIOU, Milizac (FR); Danny ALEXANDER, Neve Efraim Monoson (IL)

(21) Appl. No.: 19/001,196

(22) Filed: Dec. 24, 2024

Related U.S. Application Data
(60) Provisional application No. 63/556,781, filed on Feb. 22, 2024.

(51) Int. Cl. H04L 1/00; H04L 1/1607; H04L 5/00

(52) U.S. Cl. CPC H04L 1/0008; H04L 1/0057; H04L 1/1607; H04L 5/0055

(57) ABSTRACT

This disclosure describes systems, methods, and devices related to using padding bits for protecting trigger frames, block acknowledgement request frames, and block acknowledgement frames in Wi-Fi. A device may generate padding bits of a trigger frame, a block acknowledgment request frame, or a block acknowledgement frame; generate one or more fields signaling that the padding bits are present in the trigger frame, the block acknowledgement request frame, or the block acknowledgement frame; and cause to send the trigger frame, the block acknowledgement request frame, or the block acknowledgement frame to one or more STAs, the trigger frame, the block acknowledgement request frame, or the block acknowledgement frame including the one or more fields and the padding bits.

### CROSS-REFERENCE TO RELATED APPLICATION(S)

This application claims the benefit of U.S. Provisional Application No. 63/556,781, filed Feb. 22, 2024, the disclosure of which is incorporated herein by reference as if set forth in full.

### TECHNICAL FIELD

This disclosure generally relates to systems and methods for wireless communications and, more particularly, to padding for Trigger frame, block acknowledgment request (BAR) and block acknowledgment (BA) protection.

### BACKGROUND

Wireless devices are becoming widely prevalent and are increasingly requesting access to wireless channels. The Institute of Electrical and Electronics Engineers (IEEE) has been developing one or more standards to enable Radio Local Area Networking (RLAN). Third Generation Partnership Project (3GPP) cellular technologies also started supporting RLAN with introduction of Licensed Assisted Access (LAA) technology with LTE and later extended to New Radio (NR-U) with 5G New Radio (NR).

### BRIEF DESCRIPTION OF THE DRAWINGS

FIG. 1 is a network diagram illustrating an example network environment for enhanced frame padding, in accordance with one or more example embodiments of the present disclosure.

FIG. 2 shows an example 802.11 control frame format, in accordance with one or more embodiments of the present disclosure.

FIG. 3 shows an example 802.11 control frame format, in accordance with one or more embodiments of the present disclosure.

FIG. 4 shows an example format of an 802.11 trigger frame, in accordance with one or more embodiments of the present disclosure.

FIG. 5 shows an example special user information field of an 802.11 trigger frame, in accordance with one or more embodiments of the present disclosure.

FIG. 6 shows an example format of a trigger frame including the special user information field of FIG. 5, in accordance with one or more embodiments of the present disclosure.

FIG. 7 shows an example format of an 802.11 trigger frame including an extended special user info field, in accordance with one or more embodiments of the present disclosure.

FIG. 8 shows an example 802.11 control frame format, in accordance with one or more embodiments of the present disclosure.

FIG. 9A shows an example block acknowledgement frame format, in accordance with one or more embodiments of the present disclosure.

FIG. 9B shows an example block acknowledgement frame format, in accordance with one or more embodiments of the present disclosure.

FIG. 10 shows an example BAR format, in accordance with one or more embodiments of the present disclosure.

FIG. 11 shows an example BAR format, in accordance with one or more embodiments of the present disclosure.

FIG. 12 shows an example BAR format, in accordance with one or more embodiments of the present disclosure.

FIG. 13 shows an example BAR format, in accordance with one or more embodiments of the present disclosure.

FIG. 14 shows an example BAR format, in accordance with one or more embodiments of the present disclosure.

FIG. 15 shows an example BAR format, in accordance with one or more embodiments of the present disclosure.

FIG. 16 illustrates a flow diagram of a process for an illustrative enhanced frame padding system, in accordance with one or more example embodiments of the present disclosure.

FIG. 17 illustrates a functional diagram of an exemplary communication station that may be suitable for use as a user device, in accordance with one or more example embodiments of the present disclosure.

FIG. 18 illustrates a block diagram of an example machine upon which any of one or more techniques (e.g., methods) may be performed, in accordance with one or more example embodiments of the present disclosure.

FIG. 19 is a block diagram of a radio architecture in accordance with some examples.

FIG. 20 illustrates an example front-end module circuitry for use in the radio architecture of FIG. 19, in accordance with one or more example embodiments of the present disclosure.

FIG. 21 illustrates an example radio IC circuitry for use in the radio architecture of FIG. 19, in accordance with one or more example embodiments of the present disclosure.

FIG. 22 illustrates an example baseband processing circuitry for use in the radio architecture of FIG. 19, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

The IEEE 802.11 standards define Wi-Fi communications, including the structures, contents, and uses of trigger frames, black acknowledgement request (BAR) frames, and block acknowledgement (BA) frames. Instead of transmitting an individual acknowledgement (ACK) for every frame, multiple frames may be acknowledged together using a single BA frame that signals multiple frames that have been received. Trigger frame, BA, and BAR protection have been discussed for 802.11 to improve the security of trigger frames, BAR frames, and BA frames.

The present disclosure proposes to insert fields like key ID, MIC (message integrity check), and PN (packet number) field somewhere in the trigger frame, BAR frame, and BA frame before the FCS (frame check sequence) field so that the MIC check can be performed before continuing the following operation. However, there also have been various discussions on the need of padding due to protection or other reasons.

It is possible that when an access point (AP) receives an individually addressed control frame with protection, then the AP will need to search for the key belongs to the TA due to usage of different keys for different TA for individually addressed control frame. As a result, some form of padding is needed to provide time for AP to do key searching. It is known that padding may be required in various occasions for different control frames.

How to indicate padding so that it can be done in all these cases is unknown. It should be noted that there are multiple different reasons based on specific features (ex. usage of initial control frame, usage of initial control frame response, support of protection) to have padding. There are also cases where some devices only support some features but no other features.

Example embodiments of the present disclosure relate to systems, methods, and devices for padding for Trigger, BAR and BA protection.

The format of trigger frame, BA, and BAR is discussed to have padding under various use cases and conditions.

For trigger frame, cases are discussed with and without new UHR FCS needed for some types of initial control frame, with and without protection to have padding. Note that trigger frames currently only provide padding without ultra high reliability (UHR) FCS and without protection.

For BA frame, cases used to provide feedback and without providing feedback are discussed, and cases with protection and without protection.

Note that a BA frame currently does not have padding mechanisms and does not have feedback and protection.

For BAR frames, cases used as initial control frame and cases with and without protection are discussed.

Note that a BAR frame has been proposed as an individually addressed version of initial control frame.

Note that a BAR frame currently does not have padding mechanisms and is not used for initial control frame or a uniform format to accommodate all use cases and reasons for both devices to know when to pad and not to pad is proposed. This uniform format should also minimize potential overhead and avoid any potential interoperation issues for different control frames.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

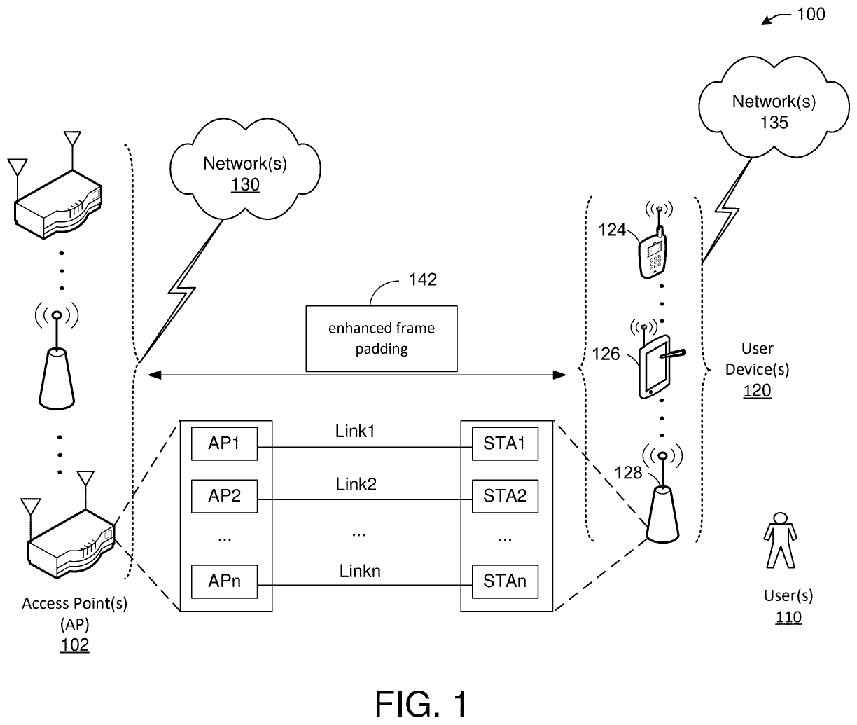

FIG. 1 is a network diagram illustrating an example network environment of enhanced frame padding, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

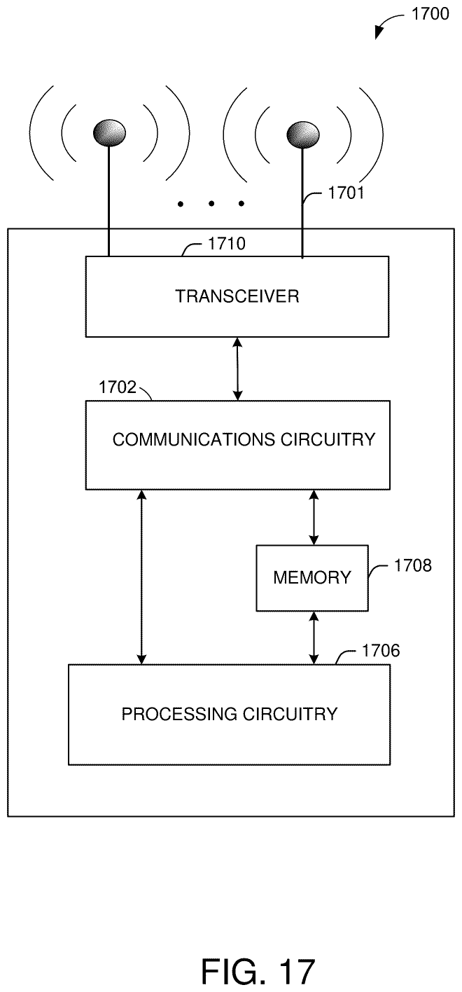

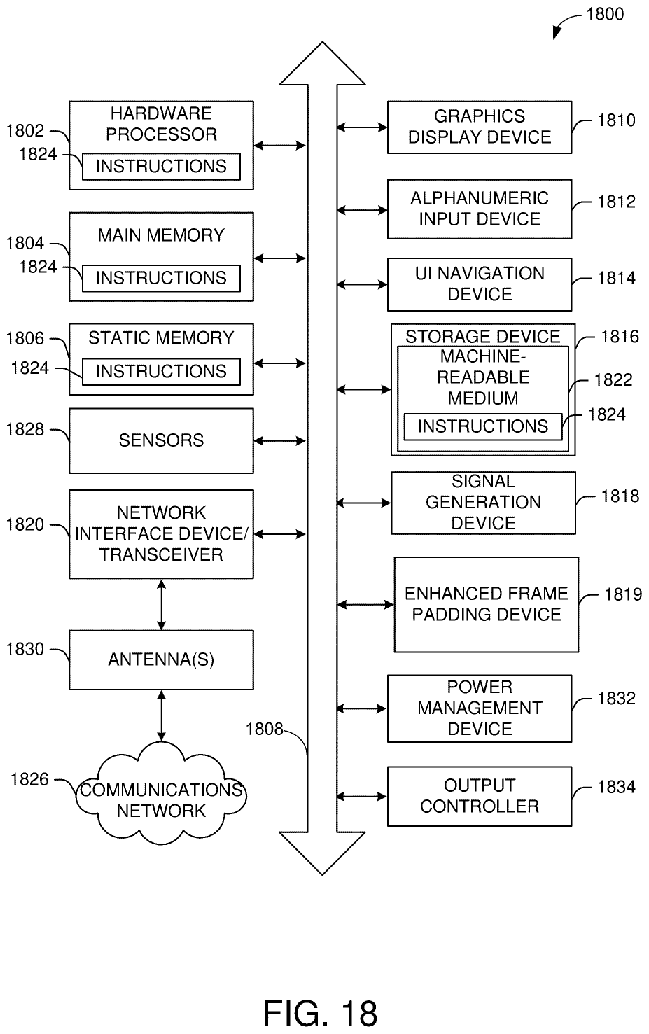

In some embodiments, the user devices 120 and the AP 102 may include one or more computer systems similar to that of the functional diagram of FIG. 17 and/or the example machine/system of FIG. 18.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced frame padding 142 (e.g., frames with enhanced padding) with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

The frames with enhanced frame padding 142 may include trigger frames, BAR frames, and BA frames, whose protection have been discussed to improve their security. A proposal herein is to insert fields like key ID, MIC, and PN field somewhere in the trigger frame, BAR frame, and BA frame before FCS field so that MIC check can be done before continuing the following operation. However, there also have been various discussions on the need for padding due to protection or other reasons. It is possible that when AP receives an individually addressed control frame with protection, then the AP will need to search for the key that belongs to the transmitter address (TA) due to usage of different keys for different TA for individually addressed control frame. As a result, some form of padding is needed to provide time for AP to do key searching.

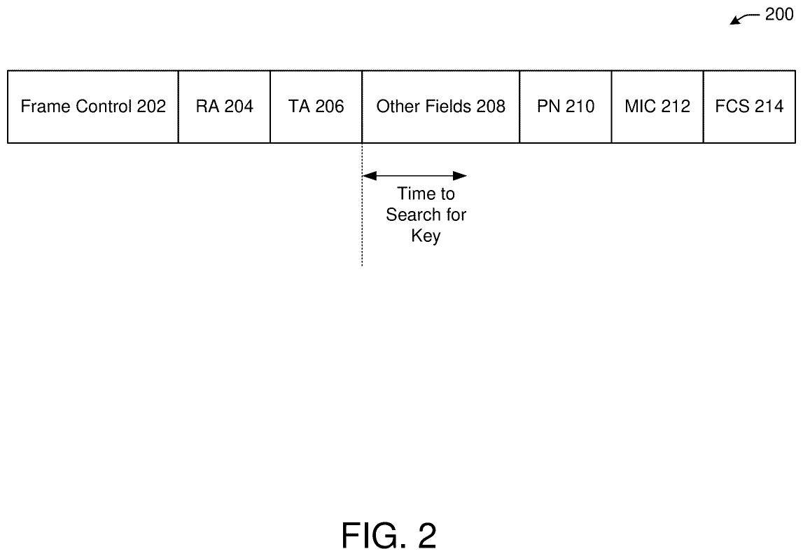

FIG. 2 shows an example 802.11 control frame format 200, in accordance with one or more embodiments of the present disclosure.

Referring to FIG. 2, an 802.11 control frame may include a frame control field 202, a receiver address (RA) 204, a transmitter address (TA) 206, other possible fields 208, a packet number (PN) 210, a MIC 212, and an FCS 214.

As shown in FIG. 2, when AP receives an individually addressed control frame with protection, then the AP will need to search for the key that belongs to the transmitter address (TA) 206 due to usage of different keys for different TA for individually addressed control frame. As a result, some form of padding is needed to provide time for AP to perform key searching.

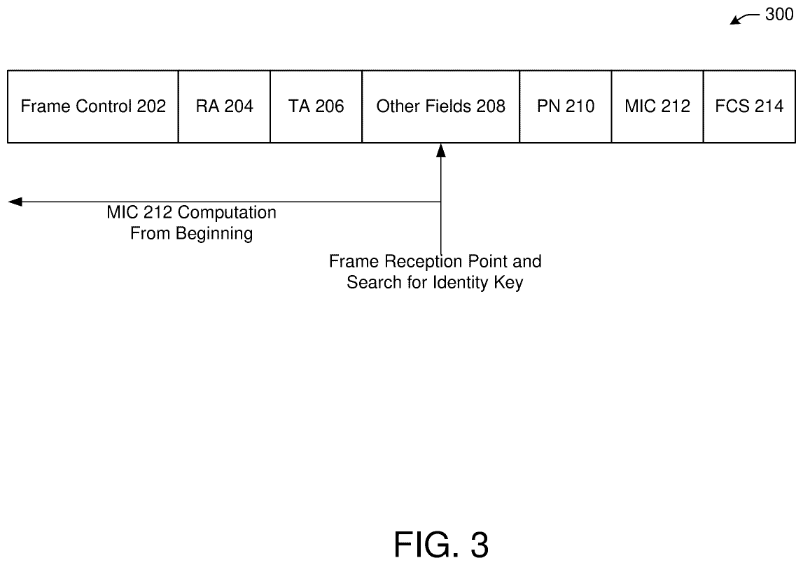

FIG. 3 shows an example 802.11 control frame format 300, in accordance with one or more embodiments of the present disclosure.

Referring to FIG. 2, an 802.11 control frame may include the frame control field 202, the receiver address (RA) 204, the transmitter address (TA) 206, other possible fields 208, the packet number (PN) 210, the MIC 212, and the FCS 214.

After finding the key belongs to the TA 206 of an individually addressed control frame, the reception of the control frame is in the middle of the control frame, but the MIC 212 computation may start from the beginning of the control frame, which means that MIC 212 computation has to catch up the reception of the control frame. If MIC 212 computation is not fast enough to catch up the reception of the control frame, then padding is required to help MIC 212 computation to catch up.

Control frames like BA may carry information for various feedback that is to be defined in 802.11 UHR. For example, feedback for link adaptation and coexistence may be included in a BA or other 802.11 control frames. As a result, the control frames like BA may need to include padding to allow the receiver of the control frame to prepare for changing transmission parameters for a following transmission.

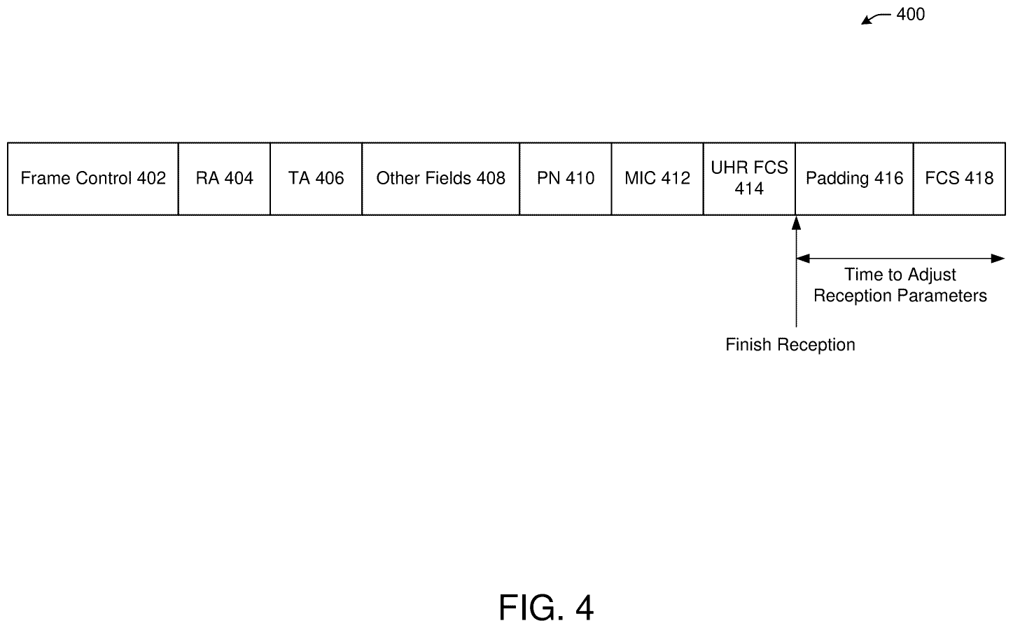

Control frames like trigger frames may be used to move a client device out of the low power mode and increase bandwidth from smaller bandwidth to higher bandwidth. However, the client needs to finish reception first and then transition to adjusting reception parameters. An example is shown in FIG. 4 with the additional FCS for the 802.11bn device to finish reception.

FIG. 4 shows an example format of an 802.11 trigger frame, in accordance with one or more embodiments of the present disclosure.

Referring to FIG. 4, the 802.11 trigger frame may include a frame control field 402, an RA 404, a TA 406, other possible fields 408, a PN 410, a MIC 412, a UHR FCS 414, padding 416, and an FCS 418. In the trigger frame of FIG. 4, the UHR FCS 414 is added to allow the receiving device to finish reception of the trigger frame and adjust reception parameters.

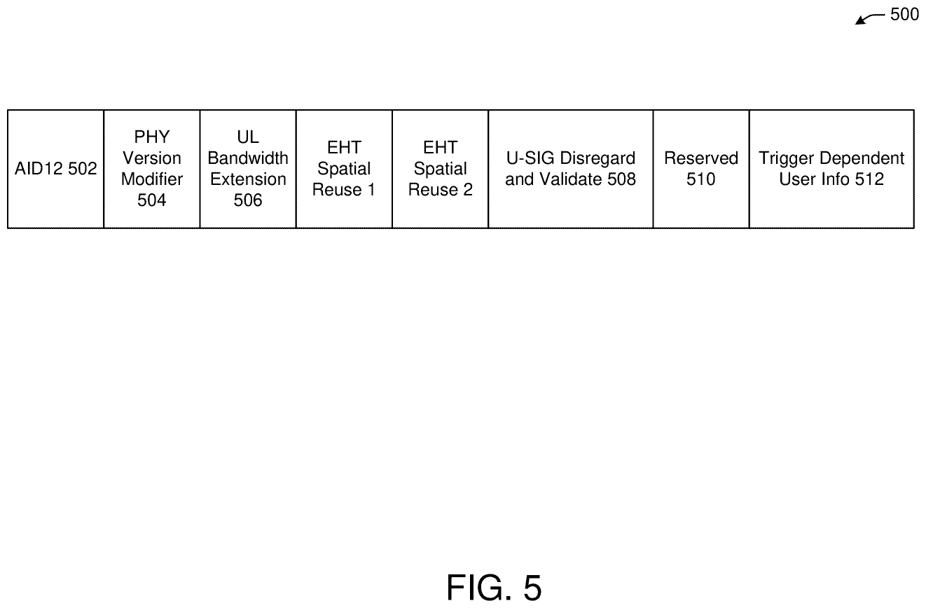

FIG. 5 shows an example special user information field 500 of an 802.11 trigger frame, in accordance with one or more embodiments of the present disclosure.

Referring to FIG. 5, the proposed design will work for all variants of trigger frames. To allow easy differentiation with and without an additional FCS for UHR, one bit is proposed in the trigger frame to indicate existence of an additional UHR FCS (e.g., the UHR FCS 414 of FIG. 4). It is possible that when UHR FCS is used in a group-addressed control frame where some receivers support protection and some receivers do not support protection. To help the devices that do not support protection to know the format, one bit is proposed in the trigger frame to indicate existence of an additional PN field and MIC field in the trigger frame. To allow early computation of the MIC to minimize the overhead of the required padding, it is proposed to have one bit indication of key ID to indicate the usage of key

The special user info field 500 may include an association identifier (AID) 502 from bits B0-B11, a PHY version identifier 504 from bits B12-B14, a UL bandwidth extension 506 from bits B15-B16, an EHT spatial reuse 1 from bits B17-B20, an EHT spatial reuse 2 from bits B21-B24, a U-SIG disregard and validate 508 from bits B25-B36, reserved bits 510 from bits B37-B39, and trigger dependent user info 512 of variable length. The location of the additional bits can be in the reserved bits 510 in the special user info field 500 in a trigger frame.

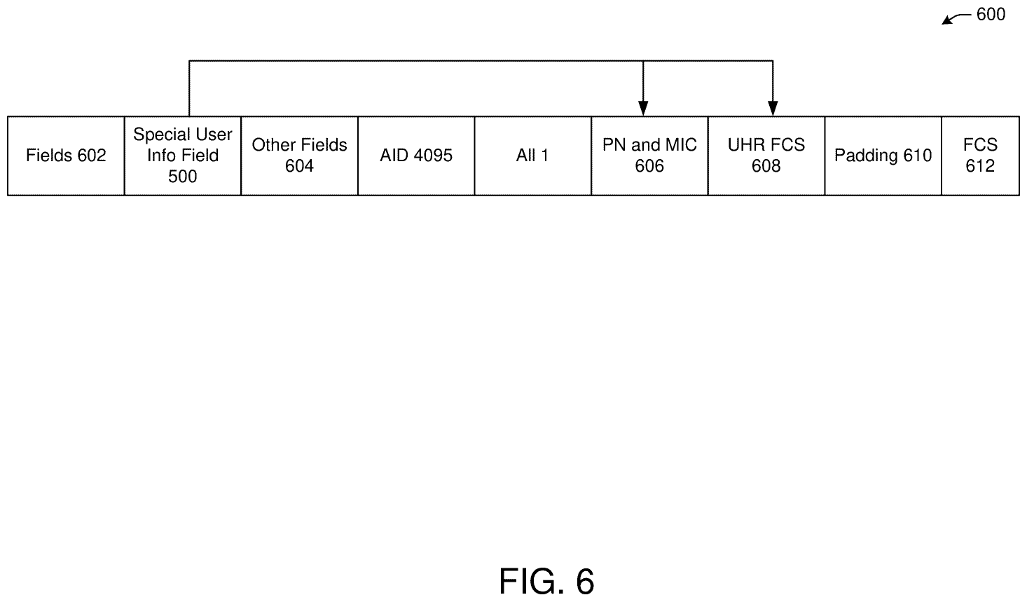

FIG. 6 shows an example format 600 of a trigger frame including the special user information field 500 of FIG. 5, in accordance with one or more embodiments of the present disclosure.

Referring to FIG. 6, the trigger frame may include fields 602, the special user info field 500, other fields 604, an AID 4095 (12 bits), an all 1 (4 bits), a PN and MIC 606, an UHR FCS 608, padding 610, and an FCS 612. The special user info field 500 may signal the inclusion of the PN and MIC 606 and the additional UHR FCS 608.

There may not be enough reserved bits available in the special user info field 500 to signal the inclusion of the PN and MIC 606 and the additional UHR FCS 608, so the location of the additional bits can be in some fields of a frame control like a retry field (e.g., bit B11) as shown below in Table 1. Some legacy devices may discard the control frame if bit B8, B9, or B10 is set to value other than 0. A protected frame and plus HTC (high throughput control) maybe used in the future.

TABLE 1
Frame Control Subfield Values Within Control Frames
Carried in a Non-SIG PPDU

| | | | | To | From | More | | | | | |
|---|---|---|---|---|---|---|---|---|---|---|---|
| | Protocol | Type | | DS | DS | Frag | Retry | Power | More | Protected | +HTC |
| Field: | Version | (Control) | Subtype | (0) | (0) | (0) | (0) | Mgmt | Data | Frame | (0) |
| Bits: | B0-B1 | B2-B3 | B4-B7 | B8 | B9 | B10 | B11 | B12 | B13 | B14 | B15 |

An extended special user info field may be present only if the special user info field 500 is present.

The extended special user info can use a different reserved AID like 2006 to indicate the additional extension of the special user info field 500.

The extended special user info may be the same size as the special user info field 500 to maintain the user info field 500 structure and allow correct parsing for legacy STAs.

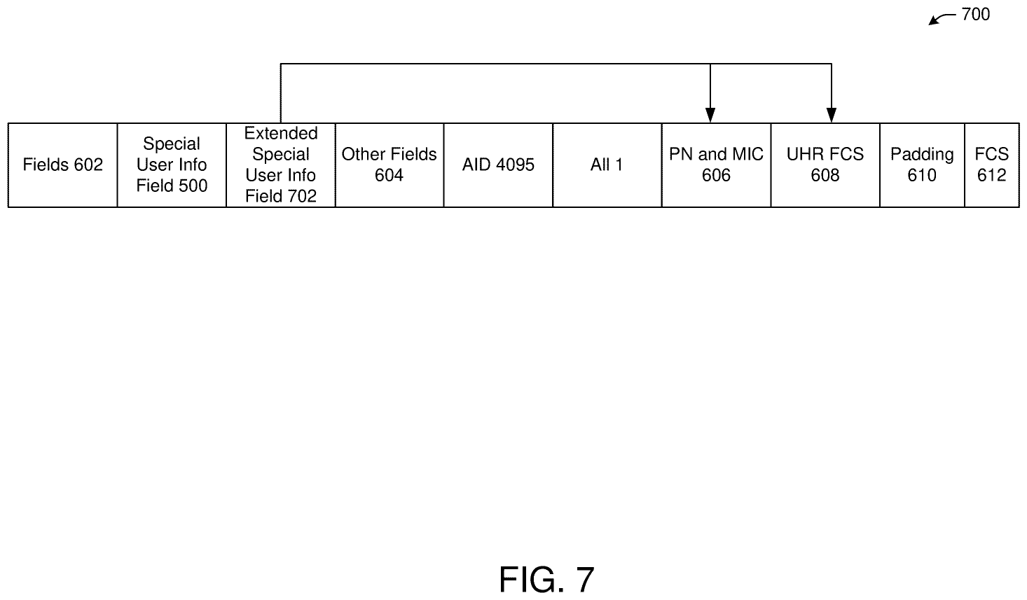

FIG. 7 shows an example format 700 of a trigger frame including an extended special user info field, in accordance with one or more embodiments of the present disclosure.

Referring to FIG. 7, the format 700 of the trigger frame may include the format 600 of FIG. 6, with an extended special user info field 702 as described above.

Alternatively, the location of the additional bits to signal the inclusion of the PN and MIC 606 and the additional UHR FCS 608 may be in an additional control field after the 12 bits padding indication.

An example AID12 subfield encoding is shown below in Table 2.

TABLE 2
AID12 Subfield Encoding

| AID12 Subfield | Description |
|---|---|
| 0 | User info field allocates one or |
| | more contiguous RA-RUs for associated STAs |
| 1-2007 | User info field is addressed to an associated STA |
| | whose AID is equal to the value in the AID12 subfield |
| 2008-2044 | Reserved |
| 2045 | User info field allocates one or |
| | more contiguous RA-RUs for unassociated STAs |
| 2046 | Unallocated RU |
| 2047-4094 | Reserved |
| 4095 | Start of padding field |

Currently there are at least four bits after the padding field, set to all Is. It is possible to use these four bits to indicate the presence of the PN and MIC 606 and the additional UHR FCS 608.

It is possible to also have additional byte after the two bytes indicating the start of padding to indicate additional info.

In this case, a one-bit indication of existence of additional control field is needed at the beginning like special user info field, extended special user info field or reuse retry bit in frame control.

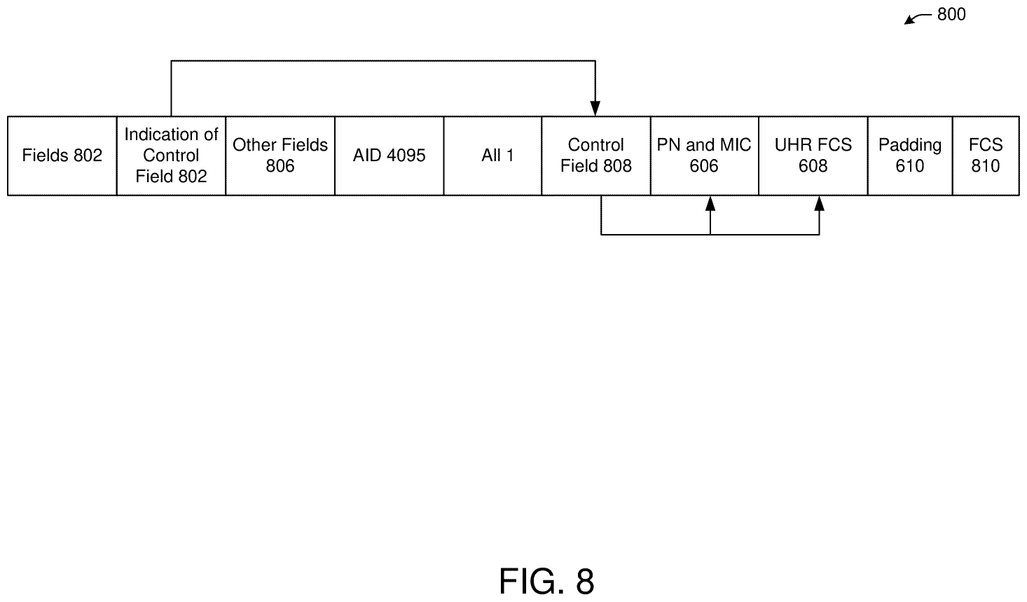

FIG. 8 shows an example 802.11 control frame format 800, in accordance with one or more embodiments of the present disclosure.

Referring to FIG. 8, the control frame may include fields 802, an indication 804 of a control field present, other fields 806, the AID 4095, the all 1, the control field 808 (e.g., signaled by the indication 804), the PN and MIC 606 (e.g., signaled by the control field 808), the UHR FCS 608 (e.g., signaled by the control field 808), the padding 612, and an FCS 810.

For the location of PN and MIC 606 and UHR FCS 608:

They may be after the indication of padding 610 (12 bits AID field indicating 4095+4 bits for byte alignment).

If UHR FCS 608 is present, then PN and MIC 606 if present will be right before the UHR FCS 608, and padding 610 will be after UHR FCS.

If UHR FCS 608 is not present, then PN and MIC 606 if present can be either before or after padding 610.

Before padding: An example is shown below in Table 3.

TABLE 3
PN and MIC 606 Signaling When UHR FCS 608 Is Not Present

| | | | | |
|---|---|---|---|---|
| AID 4095 | All 1 | PN and MIC | Padding | FCS |

After padding: An example is shown below in Table 4.

TABLE 4
PN and MIC 606 Signaling When UHR FCS 608 Is Present:

| | | | | | |
|---|---|---|---|---|---|
| AID 4095 | All 1 | Padding | PN and MIC | Padding | FCS |

The design progresses with a BA frame:

To simplify the operation, it is proposed herein to use only multi-STA BA as the only variant of acknowledgement to be used in 802.11bn to simplify the design of adding feedback, PN and MIC field, and potential padding field.

Reference: The format of multi-STA BA is shown below in Table 4.

TABLE 4
BlockAck Frame Format

| | | | | | | |
|---|---|---|---|---|---|---|
| Frame | Duration | RA (6 | TA (6 | BA | BA | FCS |
| Control | (2 | octets) | octets) | Control | Information | (4 |
| (2 octets) | octets) | | | (2 octets) | (variable) | octets) |

The format of the BA control field of Table 4 is shown below in Table 5:

TABLE 5
BA Control Field Format

| | | | | | | |
|---|---|---|---|---|---|---|
| Reserved | BA Type | Reserved | No | Memory | Mgmt | TID_INFO |
| (B0) | (B1-B4) | (B5-B8) | Memory | Configuration | Ack | (B12-B15) |
| | | | Kept | Tag | (B11) | |
| | | | (B9) | (B10) | | |

The BA frame variant encoding is shown below in Table 6.

TABLE 6
BlockAck Frame Variant Encoding

| BA Type | BA Frame Format |
|---|---|
| 0 | Reserved |
| 1 | Extended Compressed |
| 2 | Compressed |
| 3 | Multi-TID |
| 4-5 | Reserved |
| 6 | GCR |
| 7 (802.11ay) | EDMG Multi-TID |
| 8 (802.11ay) | EDMG Compressed |
| 9 (802.11ay) | Reserved |
| 10 | GLK-GCR |
| 11 | Multi-STA |
| 12-15 | Reserved |

The BA information field format for multi-STA BAs may include a per-AID TID info field of variable length, and may be repeated for each <AID, TID> tuple.

The per-AID TID info subfield format if the AID subfield is not 2045 is shown below in Table 7.

TABLE 7
Per-AID TID Info Subfield Format
When AID Subfield Is Not 2045

| | | |
|---|---|---|
| AID TID Info | Block Ack Starting | Block Ack Bitmap |
| (2 octets) | Sequence Control | (0 4, 8, |
| | (0 or 2 octets) | 16, or 32 octets) |

The AID TID Info Subfield format may be as shown in Table 8 below.

TABLE 8
AID TID Info Subfield Format

| | | |
|---|---|---|
| AID11 (B0-B10) | Ack Type (B11) | TID (B12-B15) |

A special AID may be designed to indicate that the per-AID TID info will act as a padding field.

The per AID TID info field may still use the structure as defined in section 9.3.1.8.7 multi-STA BlockAck variant of the 802.11 standard.

A fragment number subfield encoding may preserve to indicate the size of BA bitmap, which may serve as padding.

An example of the existing fragment number encoding is shown below in Table 9.

TABLE 9
Fragment Number Subfield Encoding for Multi-STA BA Variant

| | | | | BA | Max Number |
|---|---|---|---|---|---|
| | | | Fragmen- | Bitmap | of MSDUs/ |
| Fragment Number | | | tation | Subfield | A-MSDUs |
| Subfield | | | Level 3 | Length | that can be |
| B3 | B2-B1 | B0 | (On/Off) | (octets) | acknowledged |
| 0 | 0 | 0 | Off | 8 | 64 |
| 0 | 1 | 0 | | 16 | 128 |
| 0 | 2 | 0 | | 32 | 256 |
| 0 | 3 | 0 | | 4 | 32 |
| 0 | 0 | 1 | On | 8 | 16 |
| 0 | 1 | 1 | | 16 | 32 |
| 0 | 2 | 1 | | 32 | 64 |
| 0 | 3 | 1 | | 4 | 8 |
| 1 | Any | Any | | Reserved | Reserved |

Multiple Per AID TID Info fields with special AID for padding may be included.

Per AID TID Info field with padding may be after per AID TID info field for BA bitmap or per AID TID info field for feedback.

If MIC and PN is present, then MIC and PN can be:
Right before FCS.

In this case, another special AID can be used to indicate the existence of PN and MIC in the Per AID TID info field.

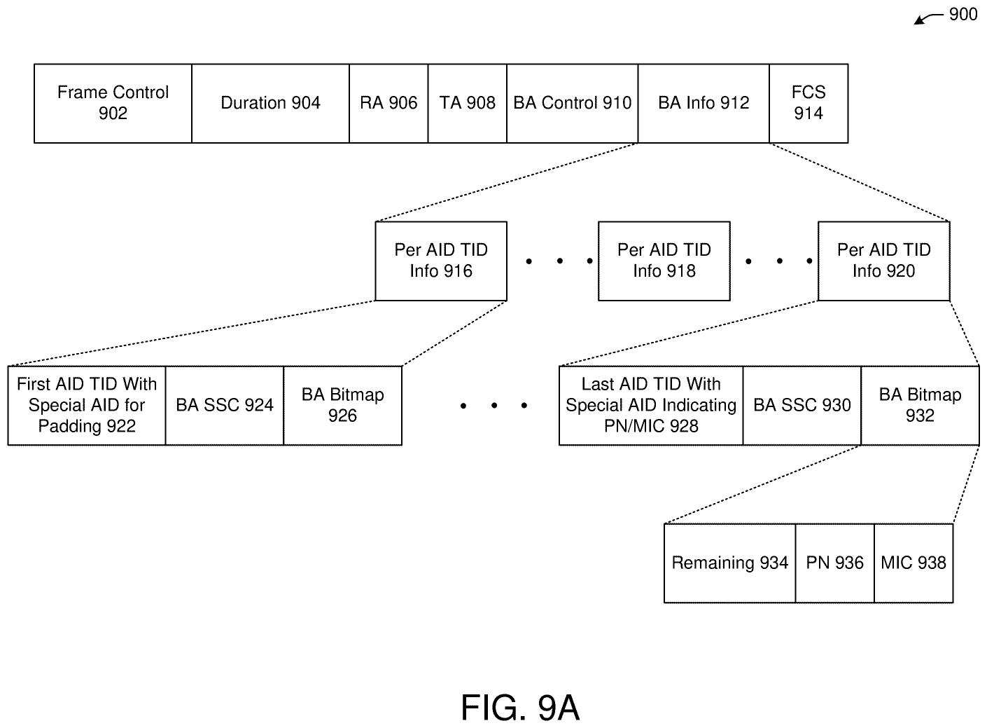

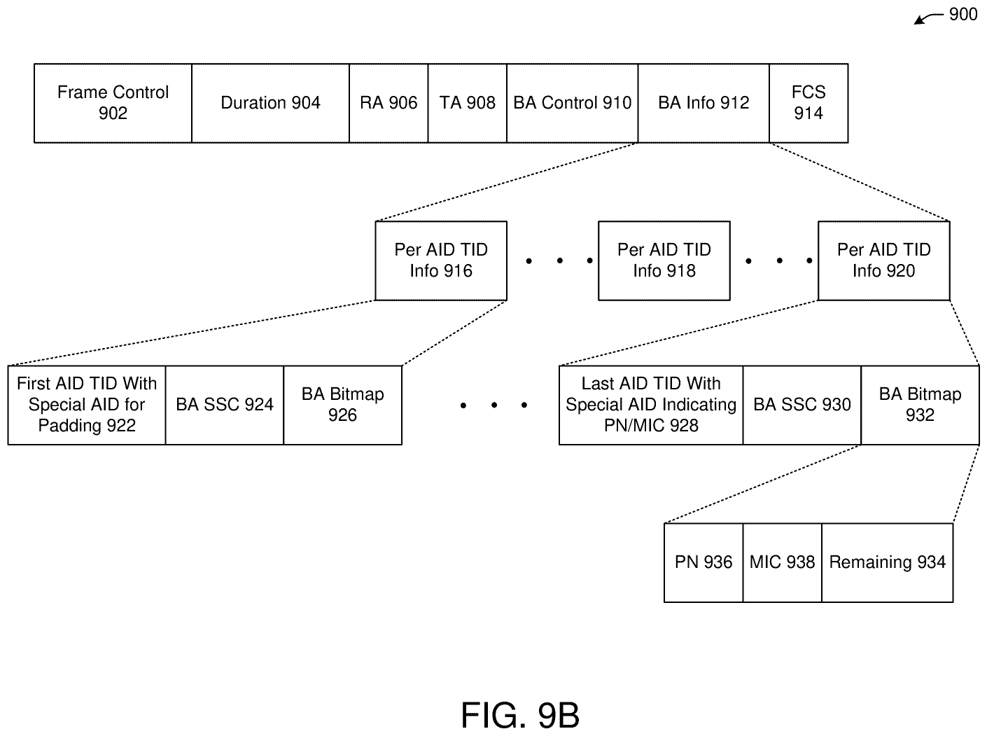

An example is shown in FIG. 9.

FIG. 9A shows an example block acknowledgement frame format 900, in accordance with one or more embodiments of the present disclosure.

Referring to FIG. 9A, the BA frame format 900 may include a frame control 902, a duration 904, an RA 906, a TA 908, BA control 910, BA info 912, and an FCS 914. The BA info 912 may include the per AID TID info fields (e.g., per AID TID info 916, per AID TID info 918, . . . per AID TID info 920). Each per AID TID info field may include a first AID TID with special AID for padding, a BA SSC, and a BA bitmap (e.g., the first AID TID with special AID for padding 922, a BA SSC 924, a BA bitmap 926, . . . , the last AID TID with special AID indicating the PN/MIC 928, BA SSC 930, and BA bitmap 932. A BA bitmap may include a remaining field 934, the PN 936, and the MIC 938.

FIG. 9B shows an example block acknowledgement frame format 950, in accordance with one or more embodiments of the present disclosure.

In FIG. 9B, the BA frame format 900 of FIG. 9A is used, but with the PN 936 and the MIC 938 preceding the remaining field 934.

Special AID can be the special AID for padding.

Special AID can be the special AID designed only to indicate inclusion of PN and MIC.

If a device supports protection of BA frame and the peer device supports protection of BA frame, then when the device receives multi-STA BA from the peer device, then it can assume PN and MIC field will be in the received Multi-STA BA frame.

The design is continued with a BAR frame:

Consider only compressed BAR variant and Multi-TID BAR variant to be used in IEEE 802.11bn (11bn).

Reference: The format of compressed BAR and Multi-TID BAR is shown below in Table 10.

TABLE 10
BA Request Frame Format

| | | | | | | |
|---|---|---|---|---|---|---|
| Frame | Duration | RA (6 | TA (6 | BAR | BAR | FCS |
| Control | (2 | octets) | octets) | Control | Information | (4 |
| (2 octets) | octets) | | | (2 octets) | (variable) | octets) |

Table 11 below shows an example of the BAR Control field format.

TABLE 11
BAR Control Field Format

| | | | |
|---|---|---|---|
| Reserved | BAR Type | Reserved | TID_Info |
| (bit B0) | (bits B1-B4) | B (bits B5-B11) | (bits B12-B15) |

Table 12 below shows BA Request Frame Variant Encoding.

TABLE 12
BA Request Frame Variant Encoding (802.11ax)

| BAR Type | BA Request Frame Variant |
|---|---|
| 0 | Reserved |
| 1 | Extended Compressed |
| 2 | Compressed |
| 3 | Multi-TID |
| 4-5 | Reserved |
| 6 | GCR |
| 7-9 | Reserved |
| 10 | GLK-GCR |
| 11-15 | Reserved |

The BAR info of a compressed BAR is shown below in Table 13.

TABLE 13
BA Starting Sequence Control Subfield Format

| | |
|---|---|
| Fragment Number (0) | Starting Sequence Number |
| (bits B0-B3) | (bits B4-B15) |

The BAR info of a multi-TID BAR includes a per TID info field of 2 octets followed by a BA starting sequence control field of 2 octets, and the BA starting sequence control field may be repeated for each TID.

The per TID info subfield format may include a reserved field from bits B0-B11 followed by a TID value field of bits B12-B15.

For a compressed BAR:

A bit can be used to indicate the solicitation of additional feedback other than BA.

Have UHR FCS, padding, and PN and MIC between SSN and FCS.

If UHR FCS is present, padding if present is after UHR FCS, PN and MIC if present is before UHR FCS.

If UHR FCS Is not present, and PN and MIC is present, padding if present:
Before PN and MIC.
After PN and MIC.

Two devices know the existing of UHR FCS, and PN and MIC through the following methods:

If both sides negotiate UHR FCS for compressed BAR and compressed BAR is received from the peer, then assumes that UHR FCS is always there.

A bit can be used to indicate the existence of UHR FCS.

Which serves as the indication that the BAR frame is an initial control frame.

If both sides negotiate protection for compressed BAR and compressed BAR is received from the peer, then assumes that PN and MIC fields are always there.

Location of additional bits can be in:

BAR Control.

Additional control fields right after BAR Info.

If there is a need for an additional control field then one bit to indicate the existence of additional control fields in BAR Control.

An example is shown below in Table 14 if PN and MIC are present and no padding field, and PN and MIC is after the SSN field and before FCS.

TABLE 14
Frame Format When PN and MIC Are Present, No Padding Field, and
the PN and the MIC are After the SSN Field and Before the FCS

| | | | | | | | | |
|---|---|---|---|---|---|---|---|---|
| Frame | Duration | RA | TA | BA | FN | SSN | PN and | FCS |
| Control | | | | Control | | | MIC | |

An example is shown below in Table 15 if PN and MIC are present and padding is present, and PN and MIC is before padding and after FN and SSN.

TABLE 15
Frame Format When PN and MIC Are Present,
Padding Is Present, and PN and
MIC are Before the Padding and After the FN and SSN

| | | | | | | | | | |
|---|---|---|---|---|---|---|---|---|---|
| Frame | Duration | RA | TA | BA | FN | SSN | PN | Padding | FCS |
| Control | | | | Control | | | and | | |
| | | | | | | | MIC | | |

An example frame format is shown below in Tale 16 if PN and MIC are present and padding is present, and PN and MIC is after padding and before FCS.

TABLE 16
Frame Format When PN and MIC Are Present, Padding Is Present,
and PN and MIC are After Padding and Before FCS

| | | | | | | | | | |
|---|---|---|---|---|---|---|---|---|---|
| Frame | Duration | RA | TA | BA | FN | SSN | Padding | PN | FCS |
| Control | | | | Control | | | | and | |
| | | | | | | | | MIC | |

An example is shown below in Table 17 if PN and MIC are not present, padding is present, and there is a need for additional UHR FCS, and the UHR FCS is after FN and SSN follows by padding.

TABLE 17
Frame Format When PN and MIC Are Not Present, Padding
Is Present, and There Is Need for Additional UHR
FCS after FN, and SSN Is Followed by Padding

| | | | | | | | | | |
|---|---|---|---|---|---|---|---|---|---|
| Frame | Duration | RA | TA | BA | FN | SSN | UHR | Padding | FCS |
| Control | | | | Control | | | FCS | | |

An example is shown below in Table 18 if PN and MIC is present, UHR FCS is present, and padding is present, and the PN and MIC is before UHR FCS, which is after FN and SSN follows by padding.

TABLE 18
Frame Format When PN and MIC Are Present, UHR FCS Is
Present, Padding Is Present, and PN and MIC are Before UHR FCS,
UHR FCS Is After FN, and SSN Is Followed by Padding

| | | | | | | | | | | |
|---|---|---|---|---|---|---|---|---|---|---|
| Frame | Duration | RA | TA | BA | FN | SSN | PN | UHR | Padding | FCS |
| Control | | | | Control | | | and | FCS | | |
| | | | | | | | MIC | | | |

For a multi-TID BAR:

A bit can be used to indicate the solicitation of additional feedback other than BA.

Use the reserved field in the per TID info to indicate start of special information like UHR FCS, PN and MIC or padding.

Per TID info can be all 1.

The following TID value can be all 1 as well.

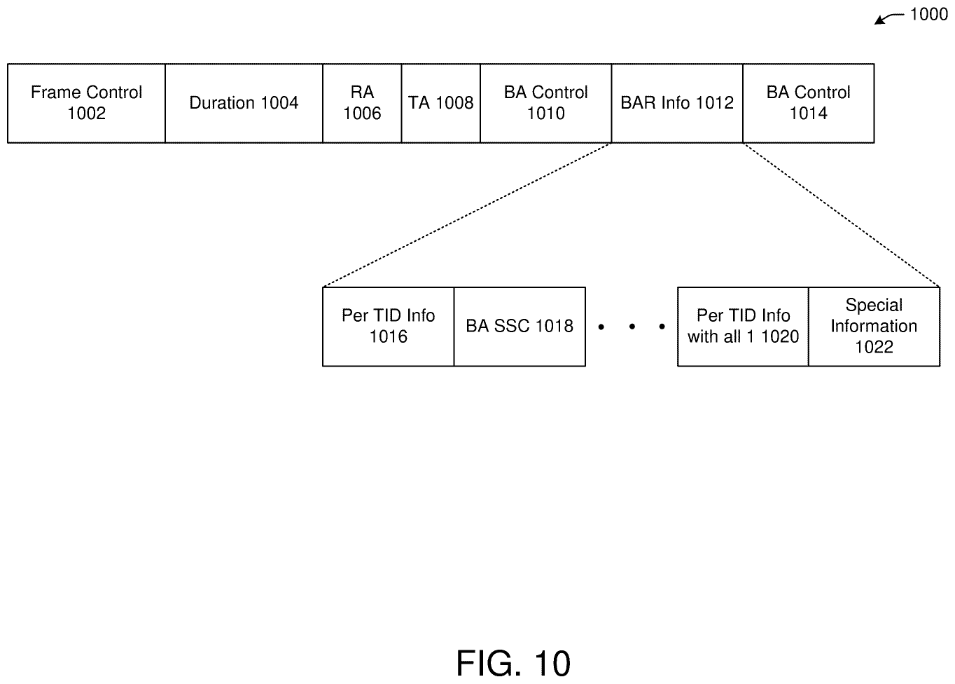

An example is shown in FIG. 10.

FIG. 10 shows an example BAR format 1000, in accordance with one or more embodiments of the present disclosure.

Referring to FIG. 10, the BAR format 1000 may include a frame control 1002, a duration 1004, an RA 1006, a TA 1008, a BA control 1010, a BAR info field 1012, and a BA control 1014. The BAR info field 1012 may include a per TID info field 1016, a BA SSC 1018, a per TID info with all 1 1020, and a special information field 1022.

If UHR FCS is present, padding is after UHR FCS if present, PN and MIC is before UHR FCS if present.

If UHR FCS Is not present, and PN and MIC are present, padding.

Before PN and MIC if present.

After PN and MIC if present.

Two devices know the existence of UHR FCS, and PN and MIC through the following methods.

If both sides negotiate UHR FCS for Multi-TID BAR and Multi-TID BAR is received from the peer, then assumes that UHR FCS is always there.

A bit can be used to indicate the existence of UHR FCS.

Which serves as the indication that the BAR frame is an initial control frame.

If both sides negotiate protection for Multi-TID BAR and Multi-TID BAR is received from the peer, then assumes that PN and MIC fields are always there.

Location of additional bits can be in:

BAR Control.

Additional control fields right after Per TID Info with all 1.

If there is a need for an additional control field then one bit to indicate the existence of additional control fields in BAR Control.

Several examples are shown below.

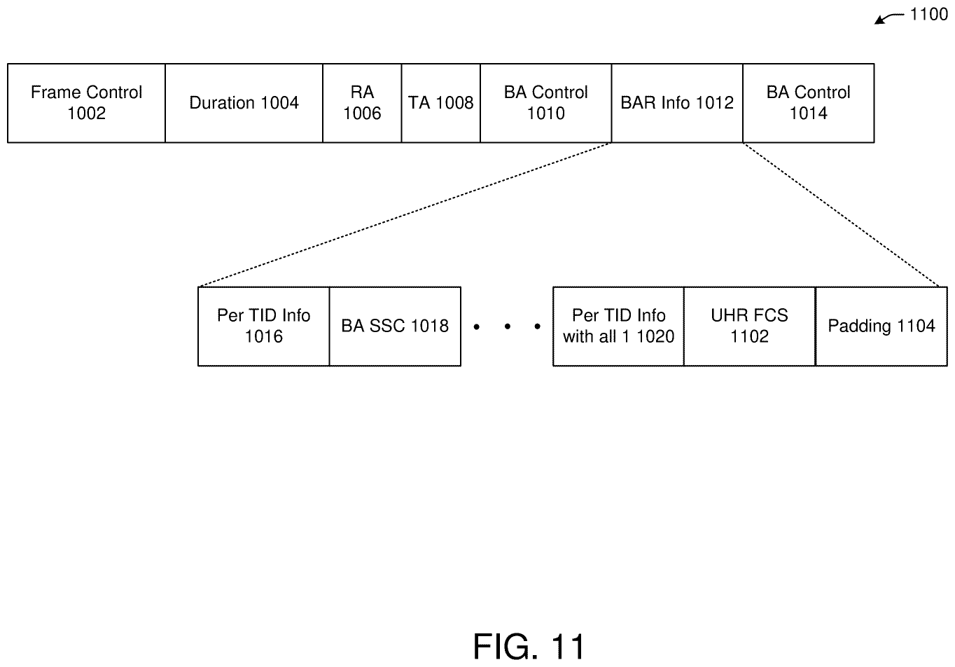

An example with UHR FCS and padding is shown in FIG. 11.

FIG. 11 shows an example BAR format 1100, in accordance with one or more embodiments of the present disclosure.

Referring to FIG. 11, the BAR format 1100 uses the BAR format 1000 of FIG. 10, except that after the per TID info with all 1 1020, there may be a UHR FCS 1102 and padding 1104.

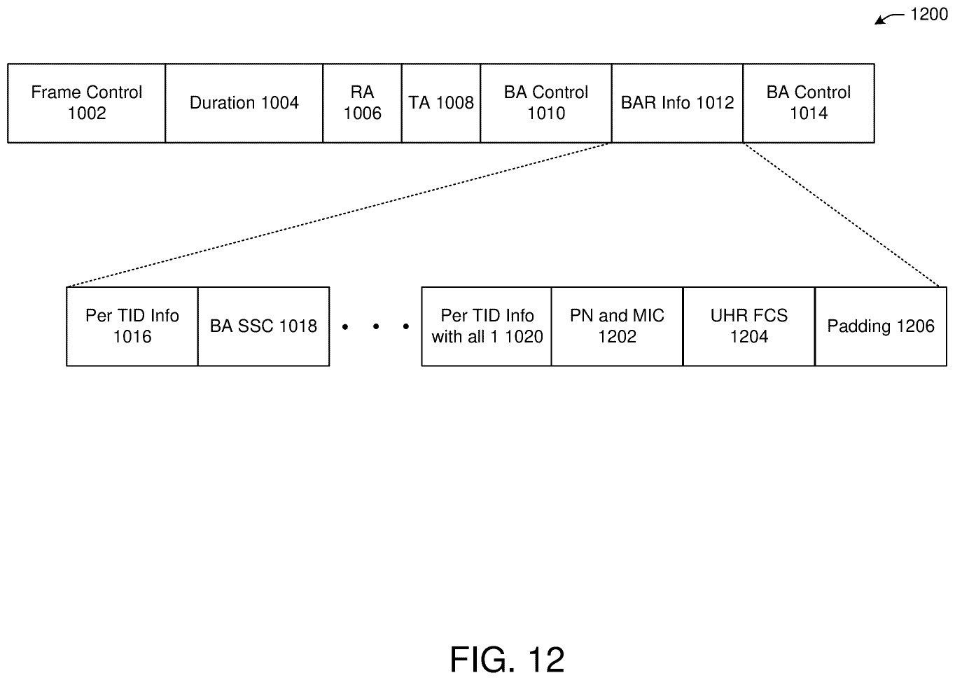

An example with PN and MIC and UHR FCS and padding is shown in FIG. 12.

FIG. 12 shows an example BAR format 1200, in accordance with one or more embodiments of the present disclosure.

Referring to FIG. 12, the BAR format 1200 uses the BAR format 1000 of FIG. 10, except that after the per TID info with all 1 1020, there may be a PN and MIC 1202, UHR FCS 1204, and padding 1206.

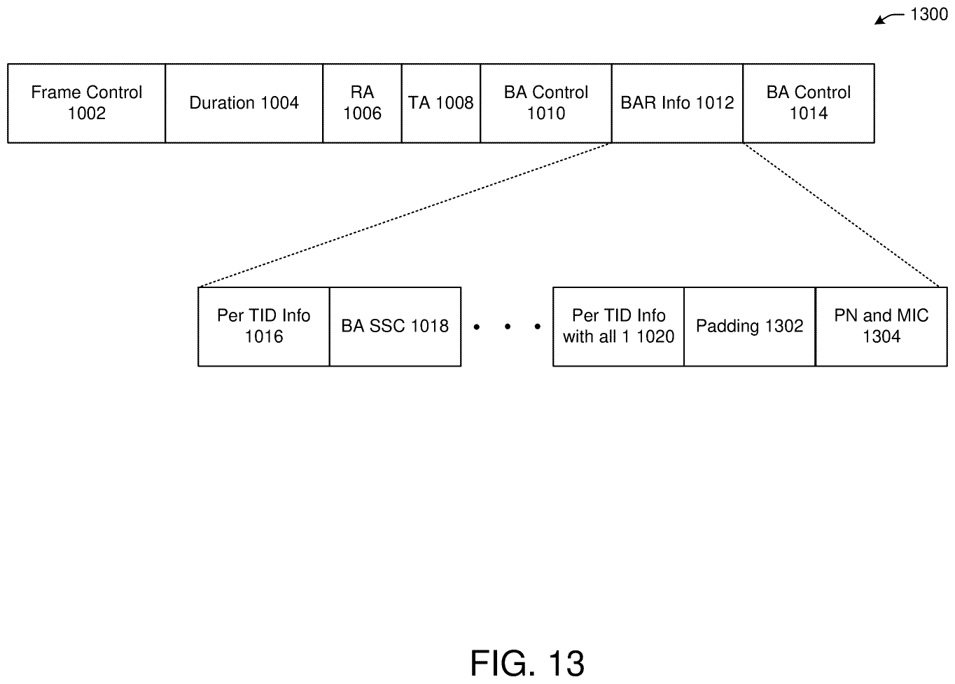

An example with PN and MIC and padding after MIC is shown in FIG. 13.

FIG. 13 shows an example BAR format 1300, in accordance with one or more embodiments of the present disclosure.

Referring to FIG. 13, the BAR format 1300 uses the BAR format 1000 of FIG. 10, except that after the per TID info with all 1 1020, there may be padding 1302 and a PN and MIC 1304.

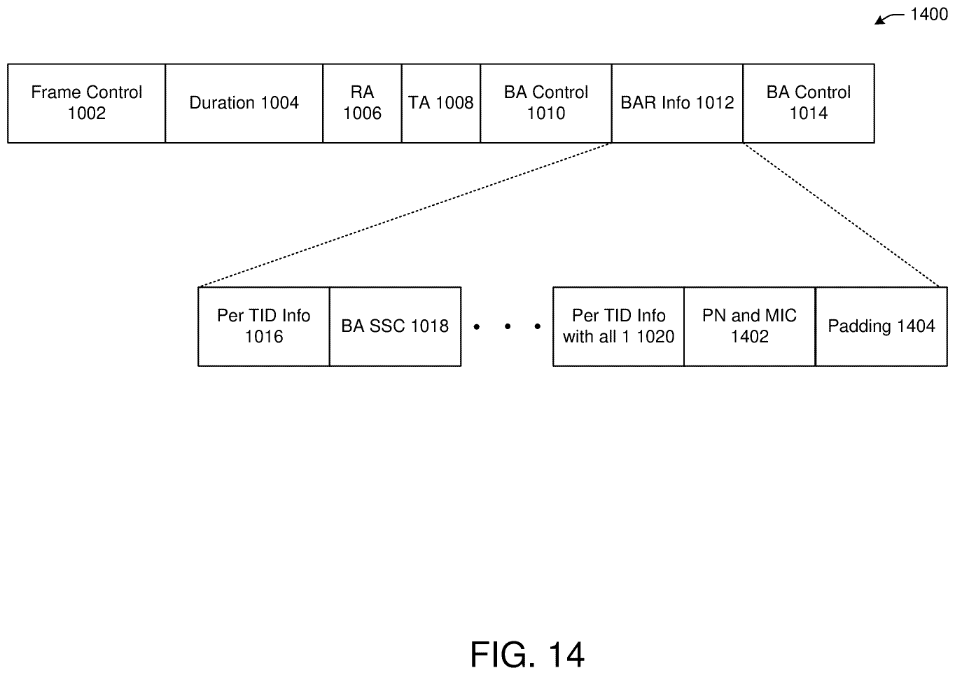

An example with PN and MIC and padding after PN and MIC is shown in FIG. 14.

FIG. 14 shows an example BAR format 1400, in accordance with one or more embodiments of the present disclosure.

Referring to FIG. 14, the BAR format 1400 uses the BAR format 1000 of FIG. 10, except that after the per TID info with all 1 1020, there may be a PN and MIC 1402 and padding 1404.

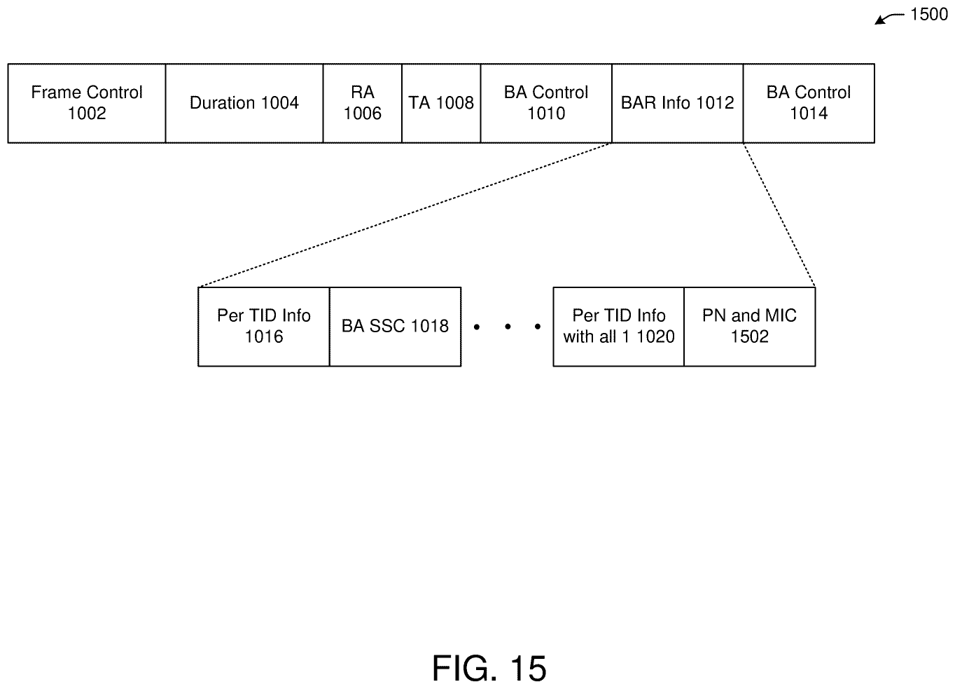

An example with PN and MIC without padding is shown in FIG. 15.

FIG. 15 shows an example BAR format 1500, in accordance with one or more embodiments of the present disclosure.

Referring to FIG. 15, the BAR format 1500 uses the BAR format 1000 of FIG. 10, except that after the per TID info with all 1 1020, there may be a PN and MIC 1502.

How two devices know how much padding is needed when one device sends a control frame that needs padding to the peer device is discussed below.

Two devices negotiate padding for the following reasons separately.

Required padding for MIC computation.

Required padding after UHR FCS.

Required padding for transmission parameters adjustment for control frame with feedback.

Required padding to prepare responding control frame with protection.

Required padding to prepare responding control frame with feedback.

To put padding, first check if any condition is applicable and is satisfied for a control frame to provide padding, then have padding to be the maximum of the required padding for applicable and satisfied conditions.

For example, if:

Required padding for MIC computation is 8 microseconds (us).

Required padding after UHR FCS is 16 us.

Required padding for transmission parameters adjustment for control frame with feedback is 12 us.

For a control frame that satisfies condition 1 and 3, then only provides padding of 12 us=max (12, 8).

It is understood that the above descriptions are for the purposes of illustration and are not meant to be limiting.

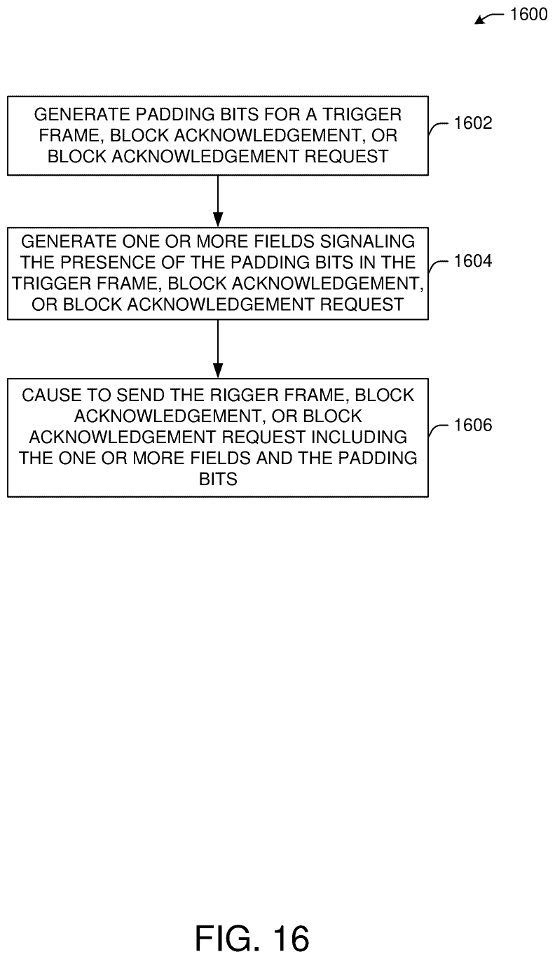

FIG. 16 illustrates a flow diagram of illustrative process 1600 for an enhanced frame padding system, in accordance with one or more example embodiments of the present disclosure.

At block 1602, a device (e.g., the user device(s) 120 and/or the AP 102 of FIG. 1 and/or the enhanced frame padding device 1819 of FIG. 18) may generate padding bits for a trigger frame, BA frame, or BAR frame.

At block 1604, the device may generate one or more fields signaling the presence of the padding bits in the trigger frame, BA frame, or BAR frame.

At block 1606, the device may cause to send the trigger frame, the BA frame, or the BAR frame with the one or more fields and the padding bits.

It is understood that the above descriptions are for the purposes of illustration and are not meant to be limiting.

FIG. 17 shows a functional diagram of an exemplary communication station 1700, in accordance with one or more example embodiments of the present disclosure. In one embodiment, FIG. 17 illustrates a functional block diagram of a communication station that may be suitable for use as an AP 102 (FIG. 1) or a user device 120 (FIG. 1) in accordance with some embodiments. The communication station 1700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1700 may include communications circuitry 1702 and a transceiver 1710 for transmitting and receiving signals to and from other communication stations using one or more antennas 1701. The communications circuitry 1702 may include circuitry that can operate the physical layer (PHY) communications and/or medium access control (MAC) communications for controlling access to the wireless medium, and/or any other communications layers for transmitting and receiving signals. The communication station 1700 may also include processing circuitry 1706 and memory 1708 arranged to perform the operations described herein. In some embodiments, the communications circuitry 1702 and the processing circuitry 1706 may be configured to perform operations detailed in the above figures, diagrams, and flows.

In accordance with some embodiments, the communications circuitry 1702 may be arranged to contend for a wireless medium and configure frames or packets for communicating over the wireless medium. The communications circuitry 1702 may be arranged to transmit and receive signals. The communications circuitry 1702 may also include circuitry for modulation/demodulation, upconversion/downconversion, filtering, amplification, etc. In some embodiments, the processing circuitry 1706 of the communication station 1700 may include one or more processors. In other embodiments, two or more antennas 1701 may be coupled to the communications circuitry 1702 arranged for sending and receiving signals. The memory 1708 may store information for configuring the processing circuitry 1706 to perform operations for configuring and transmitting message frames and performing the various operations described herein. The memory 1708 may include any type of memory, including non-transitory memory, for storing information in a form readable by a machine (e.g., a computer). For example, the memory 1708 may include a computer-readable storage device, read-only memory (ROM), random-access memory (RAM), magnetic disk storage media, optical storage media, flash-memory devices and other storage devices and media.

In some embodiments, the communication station 1700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1700 may include one or more antennas 1701. The antennas 1701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1700 may include one or more of a keyboard, a display, a non-volatile memory port, multiple antennas, a graphics processor, an application processor, speakers, and other mobile device elements. The display may be an LCD screen including a touch screen.

Although the communication station 1700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1700 may include one or more processors and may be configured with instructions stored on a computer-readable storage device.

FIG. 18 illustrates a block diagram of an example of a machine 1800 or system upon which any one or more of the techniques (e.g., methodologies) discussed herein may be performed. In other embodiments, the machine 1800 may operate as a standalone device or may be connected (e.g., networked) to other machines. In a networked deployment, the machine 1800 may operate in the capacity of a server machine, a client machine, or both in server-client network environments. In an example, the machine 1800 may act as a peer machine in peer-to-peer (P2P) (or other distributed) network environments. The machine 1800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1800 may include a hardware processor 1802 (e.g., a central processing unit (CPU), a graphics processing unit (GPU), a hardware processor core, or any combination thereof), a main memory 1804 and a static memory 1806, some or all of which may communicate with each other via an interlink (e.g., bus) 1808. The machine 1800 may further include a power management device 1832, a graphics display device 1810, an alphanumeric input device 1812 (e.g., a keyboard), and a user interface (UI) navigation device 1814 (e.g., a mouse). In an example, the graphics display device 1810, alphanumeric input device 1812, and UI navigation device 1814 may be a touch screen display. The machine 1800 may additionally include a storage device (i.e., drive unit) 1816, a signal generation device 1818 (e.g., a speaker), an enhanced frame padding device 1819, a network interface device/transceiver 1820 coupled to antenna(s) 1830, and one or more sensors 1828, such as a global positioning system (GPS) sensor, a compass, an accelerometer, or other sensor. The machine 1800 may include an output controller 1834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1802 for generation and processing of the baseband signals and for controlling operations of the main memory 1804, the storage device 1816, and/or the enhanced frame padding device 1819. The baseband processor may be provided on a single radio card, a single chip, or an integrated circuit (IC).

The storage device 1816 may include a machine readable medium 1822 on which is stored one or more sets of data structures or instructions 1824 (e.g., software) embodying or utilized by any one or more of the techniques or functions described herein. The instructions 1824 may also reside, completely or at least partially, within the main memory 1804, within the static memory 1806, or within the hardware processor 1802 during execution thereof by the machine 1800. In an example, one or any combination of the hardware processor 1802, the main memory 1804, the static memory 1806, or the storage device 1816 may constitute machine-readable media.

The enhanced frame padding device 1819 may carry out or perform any of the operations and processes (e.g., process 1600) described and shown above.

It is understood that the above are only a subset of what the enhanced frame padding device 1819 may be configured to perform and that other functions included throughout this disclosure may also be performed by the enhanced frame padding device 1819.

While the machine-readable medium 1822 is illustrated as a single medium, the term “machine-readable medium” may include a single medium or multiple media (e.g., a centralized or distributed database, and/or associated caches and servers) configured to store the one or more instructions 1824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1800 and that cause the machine 1800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1824 may further be transmitted or received over a communications network 1826 using a transmission medium via the network interface device/transceiver 1820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1820 may include one or more physical jacks (e.g., Ethernet, coaxial, or phone jacks) or one or more antennas to connect to the communications network 1826. In an example, the network interface device/transceiver 1820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1800 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

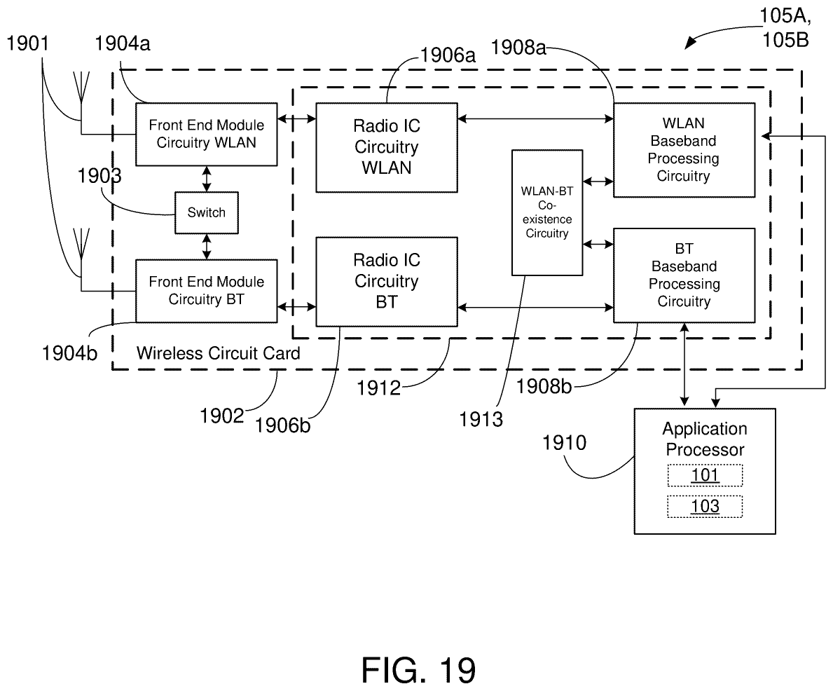

FIG. 19 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1904a-b, radio IC circuitry 1906a-b and baseband processing circuitry 1908a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1904a-b may include a WLAN or Wi-Fi FEM circuitry 1904a and a Bluetooth (BT) FEM circuitry 1904b. The WLAN FEM circuitry 1904a may include a receive signal path comprising circuitry configured to operate on WLAN RF signals received from one or more antennas 1901, to amplify the received signals and to provide the amplified versions of the received signals to the WLAN radio IC circuitry 1906a for further processing. The BT FEM circuitry 1904b may include a receive signal path which may include circuitry configured to operate on BT RF signals received from one or more antennas 1901, to amplify the received signals and to provide the amplified versions of the received signals to the BT radio IC circuitry 1906b for further processing. FEM circuitry 1904a may also include a transmit signal path which may include circuitry configured to amplify WLAN signals provided by the radio IC circuitry 1906a for wireless transmission by one or more of the antennas 1901. In addition, FEM circuitry 1904b may also include a transmit signal path which may include circuitry configured to amplify BT signals provided by the radio IC circuitry 1906b for wireless transmission by the one or more antennas. In the embodiment of FIG. 19, although FEM 1904a and FEM 1904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1906a-b as shown may include WLAN radio IC circuitry 1906a and BT radio IC circuitry 1906b. The WLAN radio IC circuitry 1906a may include a receive signal path which may include circuitry to down-convert WLAN RF signals received from the FEM circuitry 1904a and provide baseband signals to WLAN baseband processing circuitry 1908a. BT radio IC circuitry 1906b may in turn include a receive signal path which may include circuitry to down-convert BT RF signals received from the FEM circuitry 1904b and provide baseband signals to BT baseband processing circuitry 1908b. WLAN radio IC circuitry 1906a may also include a transmit signal path which may include circuitry to up-convert WLAN baseband signals provided by the WLAN baseband processing circuitry 1908a and provide WLAN RF output signals to the FEM circuitry 1904a for subsequent wireless transmission by the one or more antennas 1901. BT radio IC circuitry 1906b may also include a transmit signal path which may include circuitry to up-convert BT baseband signals provided by the BT baseband processing circuitry 1908b and provide BT RF output signals to the FEM circuitry 1904b for subsequent wireless transmission by the one or more antennas 1901. In the embodiment of FIG. 19, although radio IC circuitries 1906a and 1906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1908a-b may include a WLAN baseband processing circuitry 1908a and a BT baseband processing circuitry 1908b. The WLAN baseband processing circuitry 1908a may include a memory, such as, for example, a set of RAM arrays in a Fast Fourier Transform or Inverse Fast Fourier Transform block (not shown) of the WLAN baseband processing circuitry 1908a. Each of the WLAN baseband circuitry 1908a and the BT baseband circuitry 1908b may further include one or more processors and control logic to process the signals received from the corresponding WLAN or BT receive signal path of the radio IC circuitry 1906a-b, and to also generate corresponding WLAN or BT baseband signals for the transmit signal path of the radio IC circuitry 1906a-b. Each of the baseband processing circuitries 1908a and 1908b may further include physical layer (PHY) and medium access control layer (MAC) circuitry, and may further interface with a device for generation and processing of the baseband signals and for controlling operations of the radio IC circuitry 1906a-b.

Referring still to FIG. 19, according to the shown embodiment, WLAN-BT coexistence circuitry 1913 may include logic providing an interface between the WLAN baseband circuitry 1908a and the BT baseband circuitry 1908b to enable use cases requiring WLAN and BT coexistence. In addition, a switch 1903 may be provided between the WLAN FEM circuitry 1904a and the BT FEM circuitry 1904b to allow switching between the WLAN and BT radios according to application needs. In addition, although the antennas 1901 are depicted as being respectively connected to the WLAN FEM circuitry 1904a and the BT FEM circuitry 1904b, embodiments include within their scope the sharing of one or more antennas as between the WLAN and BT FEMs, or the provision of more than one antenna connected to each of FEM 1904a or 1904b.

In some embodiments, the front-end module circuitry 1904a-b, the radio IC circuitry 1906a-b, and baseband processing circuitry 1908a-b may be provided on a single radio card, such as wireless radio card 1902. In some other embodiments, the one or more antennas 1901, the FEM circuitry 1904a-b and the radio IC circuitry 1906a-b may be provided on a single radio card. In some other embodiments, the radio IC circuitry 1906a-b and the baseband processing circuitry 1908a-b may be provided on a single chip or integrated circuit (IC), such as IC 1912.

In some embodiments, the wireless radio card 1902 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 19, the BT baseband circuitry 1908b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

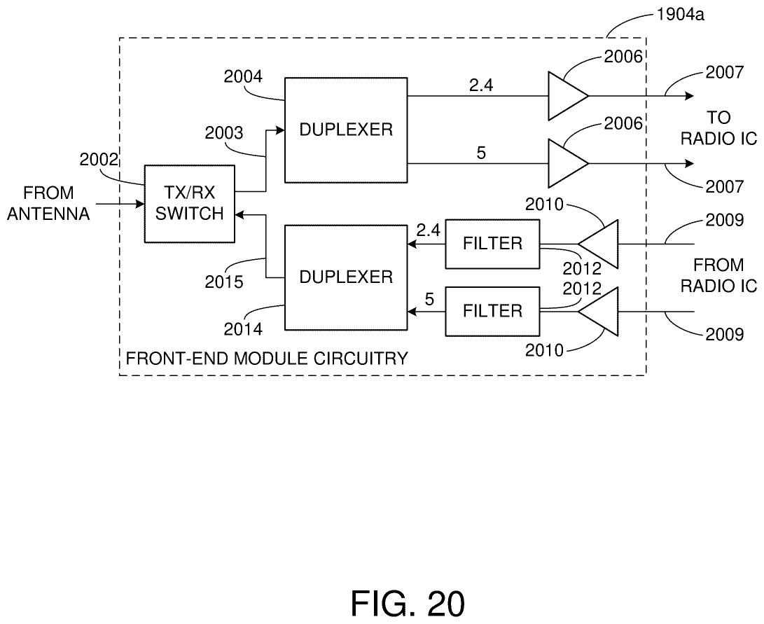

FIG. 20 illustrates WLAN FEM circuitry 1904a in accordance with some embodiments. Although the example of FIG. 20 is described in conjunction with the WLAN FEM circuitry 1904a, the example of FIG. 20 may be described in conjunction with the example BT FEM circuitry 1904b (FIG. 19), although other circuitry configurations may also be suitable.

In some embodiments, the FEM circuitry 1904a may include a TX/RX switch 2002 to switch between transmit mode and receive mode operation. The FEM circuitry 1904a may include a receive signal path and a transmit signal path. The receive signal path of the FEM circuitry 1904a may include a low-noise amplifier (LNA) 2006 to amplify received RF signals 2003 and provide the amplified received RF signals 2007 as an output (e.g., to the radio IC circuitry 1906a-b (FIG. 19)). The transmit signal path of the circuitry 1904a may include a power amplifier (PA) to amplify input RF signals 2009 (e.g., provided by the radio IC circuitry 1906a-b), and one or more filters 2012, such as band-pass filters (BPFs), low-pass filters (LPFs) or other types of filters, to generate RF signals 2015 for subsequent transmission (e.g., by one or more of the antennas 1901 (FIG. 19)) via an example duplexer 2014.

In some dual-mode embodiments for Wi-Fi communication, the FEM circuitry 1904a may be configured to operate in either the 2.4 GHz frequency spectrum or the 5 GHz frequency spectrum. In these embodiments, the receive signal path of the FEM circuitry 1904a may include a receive signal path duplexer 2004 to separate the signals from each spectrum as well as provide a separate LNA 2006 for each spectrum as shown. In these embodiments, the transmit signal path of the FEM circuitry 1904a may also include a power amplifier 2010 and a filter 2012, such as a BPF, an LPF or another type of filter for each frequency spectrum and a transmit signal path duplexer 2004 to provide the signals of one of the different spectrums onto a single transmit path for subsequent transmission by the one or more of the antennas 1901 (FIG. 19). In some embodiments, BT communications may utilize the 2.4 GHz signal paths and may utilize the same FEM circuitry 1904a as the one used for WLAN communications.

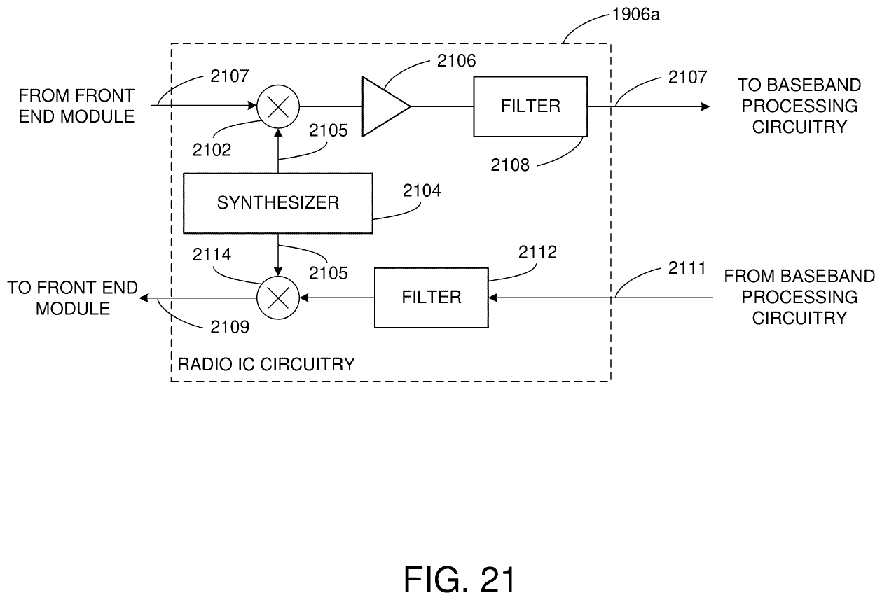

FIG. 21 illustrates radio IC circuitry 1906a in accordance with some embodiments. The radio IC circuitry 1906a is one example of circuitry that may be suitable for use as the WLAN or BT radio IC circuitry 1906a/1906b (FIG. 19), although other circuitry configurations may also be suitable. Alternatively, the example of FIG. 21 may be described in conjunction with the example BT radio IC circuitry 1906b.

In some embodiments, the radio IC circuitry 1906a may include a receive signal path and a transmit signal path. The receive signal path of the radio IC circuitry 1906a may include at least mixer circuitry 2102, such as, for example, down-conversion mixer circuitry, amplifier circuitry 2106 and filter circuitry 2108. The transmit signal path of the radio IC circuitry 1906a may include at least filter circuitry 2112 and mixer circuitry 2114, such as, for example, up-conversion mixer circuitry. Radio IC circuitry 1906a may also include synthesizer circuitry 2104 for synthesizing a frequency 2105 for use by the mixer circuitry 2102 and the mixer circuitry 2114. The mixer circuitry 2102 and/or 2114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 21 illustrates only a simplified version of a radio IC circuitry, and may include, although not shown, embodiments where each of the depicted circuitries may include more than one component. For instance, mixer circuitry 2114 may each include one or more mixers, and filter circuitries 2108 and/or 2112 may each include one or more filters, such as one or more BPFs and/or LPFs according to application needs. For example, when mixer circuitries are of the direct-conversion type, they may each include two or more mixers.

In some embodiments, mixer circuitry 2102 may be configured to down-convert RF signals 2007 received from the FEM circuitry 1904a-b (FIG. 19) based on the synthesized frequency 2105 provided by synthesizer circuitry 2104. The amplifier circuitry 2106 may be configured to amplify the down-converted signals and the filter circuitry 2108 may include an LPF configured to remove unwanted signals from the down-converted signals to generate output baseband signals 2107. Output baseband signals 2107 may be provided to the baseband processing circuitry 1908a-b (FIG. 19) for further processing. In some embodiments, the output baseband signals 2107 may be zero-frequency baseband signals, although this is not a requirement. In some embodiments, mixer circuitry 2102 may comprise passive mixers, although the scope of the embodiments is not limited in this respect.

In some embodiments, the mixer circuitry 2114 may be configured to up-convert input baseband signals 2111 based on the synthesized frequency 2105 provided by the synthesizer circuitry 2104 to generate RF output signals 2009 for the FEM circuitry 1904a-b. The baseband signals 2111 may be provided by the baseband processing circuitry 1908a-b and may be filtered by filter circuitry 2112. The filter circuitry 2112 may include an LPF or a BPF, although the scope of the embodiments is not limited in this respect.

In some embodiments, the mixer circuitry 2102 and the mixer circuitry 2114 may each include two or more mixers and may be arranged for quadrature down-conversion and/or up-conversion respectively with the help of synthesizer 2104. In some embodiments, the mixer circuitry 2102 and the mixer circuitry 2114 may each include two or more mixers each configured for image rejection (e.g., Hartley image rejection). In some embodiments, the mixer circuitry 2102 and the mixer circuitry 2114 may be arranged for direct down-conversion and/or direct up-conversion, respectively. In some embodiments, the mixer circuitry 2102 and the mixer circuitry 2114 may be configured for super-heterodyne operation, although this is not a requirement.

Mixer circuitry 2102 may comprise, according to one embodiment: quadrature passive mixers (e.g., for the in-phase (I) and quadrature phase (Q) paths). In such an embodiment, RF input signal 2007 from FIG. 21 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 2105 of synthesizer 2104 (FIG. 21). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 2007 (FIG. 20) may comprise a balanced signal, although the scope of the embodiments is not limited in this respect. The I and Q baseband output signals may be provided to low-noise amplifier, such as amplifier circuitry 2106 (FIG. 21) or to filter circuitry 2108 (FIG. 21).

In some embodiments, the output baseband signals 2107 and the input baseband signals 2111 may be analog baseband signals, although the scope of the embodiments is not limited in this respect. In some alternate embodiments, the output baseband signals 2107 and the input baseband signals 2111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 2104 may be a fractional-N synthesizer or a fractional N/N+1 synthesizer, although the scope of the embodiments is not limited in this respect as other types of frequency synthesizers may be suitable. For example, synthesizer circuitry 2104 may be a delta-sigma synthesizer, a frequency multiplier, or a synthesizer comprising a phase-locked loop with a frequency divider. According to some embodiments, the synthesizer circuitry 2104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 2104 may be provided by a voltage controlled oscillator (VCO), although that is not a requirement. A divider control input may further be provided by either the baseband processing circuitry 1908a-b (FIG. 19) depending on the desired output frequency 2105. In some embodiments, a divider control input (e.g., N) may be determined from a look-up table (e.g., within a Wi-Fi card) based on a channel number and a channel center frequency as determined or indicated by the example application processor 1910. The application processor 1910 may include, or otherwise be connected to, one of the example secure signal converter 101 or the example received signal converter 103 (e.g., depending on which device the example radio architecture is implemented in).

In some embodiments, synthesizer circuitry 2104 may be configured to generate a carrier frequency as the output frequency 2105, while in other embodiments, the output frequency 2105 may be a fraction of the carrier frequency (e.g., one-half the carrier frequency, one-third the carrier frequency). In some embodiments, the output frequency 2105 may be a LO frequency (fLO).

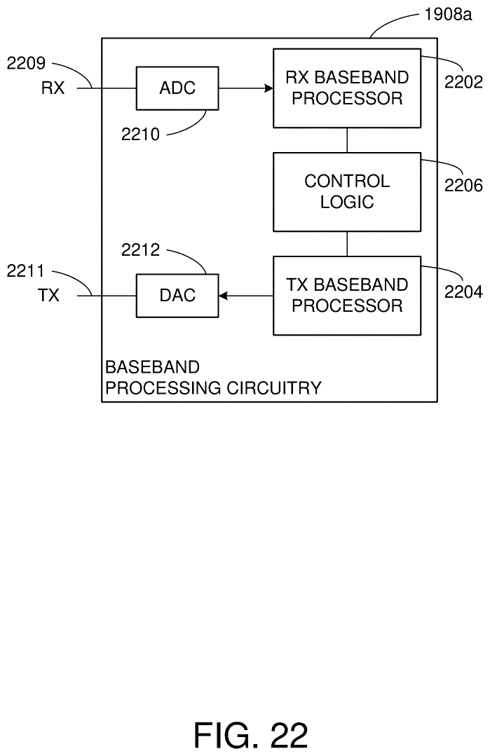

FIG. 22 illustrates a functional block diagram of baseband processing circuitry 1908a in accordance with some embodiments. The baseband processing circuitry 1908a is one example of circuitry that may be suitable for use as the baseband processing circuitry 1908a (FIG. 19), although other circuitry configurations may also be suitable. Alternatively, the example of FIG. 21 may be used to implement the example BT baseband processing circuitry 1908b of FIG. 19.

The baseband processing circuitry 1908a may include a receive baseband processor (RX BBP) 2202 for processing receive baseband signals 2109 provided by the radio IC circuitry 1906a-b (FIG. 19) and a transmit baseband processor (TX BBP) 2204 for generating transmit baseband signals 2111 for the radio IC circuitry 1906a-b. The baseband processing circuitry 1908a may also include control logic 2206 for coordinating the operations of the baseband processing circuitry 1908a.

In some embodiments (e.g., when analog baseband signals are exchanged between the baseband processing circuitry 1908a-b and the radio IC circuitry 1906a-b), the baseband processing circuitry 1908a may include ADC 2210 to convert analog baseband signals 2209 received from the radio IC circuitry 1906a-b to digital baseband signals for processing by the RX BBP 2202. In these embodiments, the baseband processing circuitry 1908a may also include DAC 2212 to convert digital baseband signals from the TX BBP 2204 to analog baseband signals 2211.

In some embodiments that communicate OFDM signals or OFDMA signals, such as through baseband processor 1908a, the transmit baseband processor 2204 may be configured to generate OFDM or OFDMA signals as appropriate for transmission by performing an inverse fast Fourier transform (IFFT). The receive baseband processor 2202 may be configured to process received OFDM signals or OFDMA signals by performing an FFT. In some embodiments, the receive baseband processor 2202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 19, in some embodiments, the antennas 1901 (FIG. 19) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1901 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include an apparatus for a device for using padding bits for protecting trigger frames, block acknowledgement request frames, and block acknowledgement frames, the apparatus comprising processing circuitry coupled to storage, the processing circuitry configured to: generate padding bits of a trigger frame, a block acknowledgment request frame, or a block acknowledgement frame; generate one or more fields signaling that the padding bits are present in the trigger frame, the block acknowledgement request frame, or the block acknowledgement frame; and cause to send the trigger frame, the block acknowledgement request frame, or the block acknowledgement frame to one or more STAs, the trigger frame, the block acknowledgement request frame, or the block acknowledgement frame comprising the one or more fields and the padding bits.

Example 2 may include the apparatus of example 1 and/or any other example herein, wherein the trigger frame comprises a special user information field preceding a packet number (PN), a message integrity check (MIC), an ultra high reliability (UHR) frame check sequence (FCS), the padding bits, and an FCS, and wherein the special user information field signals that the padding bits are present.

Example 3 may include the apparatus of example 2 and/or any other example herein, wherein the trigger frame further comprises an extended special information field following the special user information field, and wherein the extended special information field signals that the PN, the MIC, and the UHR FCS are present.

Example 4 may include the apparatus of example 1 and/or any other example herein, wherein the trigger frame comprises an indication of control field signaling that a control field is present in the trigger frame, and wherein the control field signals that a PN, a MIC, and a UHR FCS are present in the trigger frame.

Example 5 may include the apparatus of example 1 and/or any other example herein, wherein the block acknowledgement frame is a multi-station block acknowledgement frame comprising a frame control field, a duration field, a receiver address, a transmitter address, a block acknowledgment control field, a block acknowledgement information field, and an FCS, wherein the block acknowledgement information field comprises a per association identifier (AID) traffic identifier (TID) information field for each AID TID tuple, and wherein the per AID TID information field comprises the padding bits.

Example 6 may include the apparatus of example 5 and/or any other example herein, wherein the per AID TID information field further comprises a block acknowledgement bitmap comprising a PN and a MIC.

Example 7 may include the apparatus of example 1 and/or any other example herein, wherein the block acknowledgement request frame is a compressed block acknowledgement request variant or a multi-traffic indicator (multi-TID) block acknowledgement request variant comprising a frame control field, a duration field, a receiver address, a transmitter address, a block acknowledgement request control field, a block acknowledgement request information field, and an FCS, and wherein at least one of the block acknowledgement request control field or the block acknowledgement request information field signals the presence of the padding bits.

Example 8 may include the apparatus of example 1 and/or any other example herein, further comprising a transceiver configured to transmit and receive wireless signals comprising the trigger frame, the block acknowledgement request frame, or the block acknowledgement frame.

Example 9 may include the apparatus of example 8 and/or any other example herein, further comprising an antenna coupled to the transceiver to cause to send the trigger frame, the block acknowledgement request frame, or the block acknowledgement frame.

Example 10 may include a non-transitory computer-readable medium storing computer-executable instructions which when executed by one or more processors of a device for using padding bits for protecting trigger frames, block acknowledgement request frames, and block acknowledgement frames result in performing operations comprising: generating padding bits of a trigger frame, a block acknowledgment request frame, or a block acknowledgement frame; generating one or more fields signaling that the padding bits are present in the trigger frame, the block acknowledgement request frame, or the block acknowledgement frame; and causing to send the trigger frame, the block acknowledgement request frame, or the block acknowledgement frame to one or more STAs, the trigger frame, the block acknowledgement request frame, or the block acknowledgement frame comprising the one or more fields and the padding bits.

Example 11 may include the non-transitory computer-readable medium of example 10 and/or any other example herein, wherein the trigger frame comprises a special user information field preceding a packet number (PN), a message integrity check (MIC), an ultra high reliability (UHR) frame check sequence (FCS), the padding bits, and an FCS, and wherein the special user information field signals that the padding bits are present.

Example 12 may include the non-transitory computer-readable medium of example 11 and/or any other example herein, wherein the trigger frame further comprises an extended special information field following the special user information field, and wherein the extended special information field signals that the PN, the MIC, and the UHR FCS are present.

Example 13 may include the non-transitory computer-readable medium of example 10 and/or any other example herein, wherein the trigger frame comprises an indication of control field signaling that a control field is present in the trigger frame, and wherein the control field signals that a PN, a MIC, and a UHR FCS are present in the trigger frame.

Example 14 may include the non-transitory computer-readable medium of example 10 and/or any other example herein, wherein the block acknowledgement frame is a multi-station block acknowledgement frame comprising a frame control field, a duration field, a receiver address, a transmitter address, a block acknowledgment control field, a block acknowledgement information field, and an FCS, wherein the block acknowledgement information field comprises a per association identifier (AID) traffic identifier (TID) information field for each AID TID tuple, and wherein the per AID TID information field comprises the padding bits.

Example 15 may include the non-transitory computer-readable medium of example 14 and/or any other example herein, wherein the per AID TID information field further comprises a block acknowledgement bitmap comprising a PN and a MIC.

Example 16 may include the non-transitory computer-readable medium of example 10 and/or any other example herein, wherein the block acknowledgement request frame is a compressed block acknowledgement request variant or a multi-traffic indicator (multi-TID) block acknowledgement request variant comprising a frame control field, a duration field, a receiver address, a transmitter address, a block acknowledgement request control field, a block acknowledgement request information field, and an FCS, and wherein at least one of the block acknowledgement request control field or the block acknowledgement request information field signals the presence of the padding bits.

Example 17 may include a method for using padding bits for protecting trigger frames, block acknowledgement request frames, and block acknowledgement frames, the method comprising: generating, by processing circuitry of a device, padding bits of a trigger frame, a block acknowledgment request frame, or a block acknowledgement frame; generating, by the processing circuitry, one or more fields signaling that the padding bits are present in the trigger frame, the block acknowledgement request frame, or the block acknowledgement frame; and causing to send, by the circuitry, the trigger frame, the block acknowledgement request frame, or the block acknowledgement frame to one or more STAs, the trigger frame, the block acknowledgement request frame, or the block acknowledgement frame comprising the one or more fields and the padding bits.

Example 18 may include the method of example 17 and/or any other example herein, wherein the trigger frame comprises a special user information field preceding a packet number (PN), a message integrity check (MIC), an ultra high reliability (UHR) frame check sequence (FCS), the padding bits, and an FCS, and wherein the special user information field signals that the padding bits are present.

Example 19 may include the method of example 17 and/or any other example herein, wherein the block acknowledgement frame is a multi-station block acknowledgement frame comprising a frame control field, a duration field, a receiver address, a transmitter address, a block acknowledgment control field, a block acknowledgement information field, and an FCS, wherein the block acknowledgement information field comprises a per association identifier (AID) traffic identifier (TID) information field for each AID TID tuple, and wherein the per AID TID information field comprises the padding bits.

Example 20 may include the method of example 17 and/or any other example herein, wherein the block acknowledgement request frame is a compressed block acknowledgement request variant or a multi-traffic indicator (multi-TID) block acknowledgement request variant comprising a frame control field, a duration field, a receiver address, a transmitter address, a block acknowledgement request control field, a block acknowledgement request information field, and an FCS, and wherein at least one of the block acknowledgement request control field or the block acknowledgement request information field signals the presence of the padding bits.

Example 21 may include an apparatus including means for: generating padding bits of a trigger frame, a block acknowledgment request frame, or a block acknowledgement frame; generating one or more fields signaling that the padding bits are present in the trigger frame, the block acknowledgement request frame, or the block acknowledgement frame; and causing to send the trigger frame, the block acknowledgement request frame, or the block acknowledgement frame to one or more STAs, the trigger frame, the block acknowledgement request frame, or the block acknowledgement frame comprising the one or more fields and the padding bits.

Example 22 may include a method of communicating in a wireless network as shown and described herein.

Example 23 may include a system for providing wireless communication as shown and described herein.

Example 24 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus for a device for using padding bits for protecting trigger frames, block acknowledgement request frames, and block acknowledgement frames, the apparatus comprising processing circuitry coupled to storage, the processing circuitry configured to:
generate padding bits of a trigger frame, a block acknowledgment request frame, or a block acknowledgement frame;
generate one or more fields signaling that the padding bits are present in the trigger frame, the block acknowledgement request frame, or the block acknowledgement frame; and
cause to send the trigger frame, the block acknowledgement request frame, or the block acknowledgement frame to one or more STAs, the trigger frame, the block acknowledgement request frame, or the block acknowledgement frame comprising the one or more fields and the padding bits.

2. The apparatus of claim 1, wherein the trigger frame comprises a special user information field preceding a packet number (PN), a message integrity check (MIC), an ultra high reliability (UHR) frame check sequence (FCS), the padding bits, and an FCS, and wherein the special user information field signals that the padding bits are present.

3. The apparatus of claim 2, wherein the trigger frame further comprises an extended special information field following the special user information field, and wherein the extended special information field signals that the PN, the MIC, and the UHR FCS are present.

4. The apparatus of claim 1, wherein the trigger frame comprises an indication of control field signaling that a control field is present in the trigger frame, and wherein the control field signals that a PN, a MIC, and a UHR FCS are present in the trigger frame.

5. The apparatus of claim 1, wherein the block acknowledgement frame is a multi-station block acknowledgement frame comprising a frame control field, a duration field, a receiver address, a transmitter address, a block acknowledgment control field, a block acknowledgement information field, and an FCS, wherein the block acknowledgement information field comprises a per association identifier (AID) traffic identifier (TID) information field for each AID TID tuple, and wherein the per AID TID information field comprises the padding bits.

6. The apparatus of claim 5, wherein the per AID TID information field further comprises a block acknowledgement bitmap comprising a PN and a MIC.

7. The apparatus of claim 1, wherein the block acknowledgement request frame is a compressed block acknowledgement request variant or a multi-traffic indicator (multi-TID) block acknowledgement request variant comprising a frame control field, a duration field, a receiver address, a transmitter address, a block acknowledgement request control field, a block acknowledgement request information field, and an FCS, and wherein at least one of the block acknowledgement request control field or the block acknowledgement request information field signals the presence of the padding bits.

8. The apparatus of claim 1, further comprising a transceiver configured to transmit and receive wireless signals comprising the trigger frame, the block acknowledgement request frame, or the block acknowledgement frame.

9. The apparatus of claim 8, further comprising an antenna coupled to the transceiver to cause to send the trigger frame, the block acknowledgement request frame, or the block acknowledgement frame.

10. A non-transitory computer-readable medium storing computer-executable instructions which when executed by one or more processors of a device for using padding bits for protecting trigger frames, block acknowledgement request frames, and block acknowledgement frames result in performing operations comprising:
generating padding bits of a trigger frame, a block acknowledgment request frame, or a block acknowledgement frame;
generating one or more fields signaling that the padding bits are present in the trigger frame, the block acknowledgement request frame, or the block acknowledgement frame; and
causing to send the trigger frame, the block acknowledgement request frame, or the block acknowledgement frame to one or more STAs, the trigger frame, the block acknowledgement request frame, or the block acknowledgement frame comprising the one or more fields and the padding bits.

11. The non-transitory computer-readable medium of claim 10, wherein the trigger frame comprises a special user information field preceding a packet number (PN), a message integrity check (MIC), an ultra high reliability (UHR) frame check sequence (FCS), the padding bits, and an FCS, and wherein the special user information field signals that the padding bits are present.

12. The non-transitory computer-readable medium of claim 11, wherein the trigger frame further comprises an extended special information field following the special user information field, and wherein the extended special information field signals that the PN, the MIC, and the UHR FCS are present.

13. The non-transitory computer-readable medium of claim 10, wherein the trigger frame comprises an indication of control field signaling that a control field is present in the trigger frame, and wherein the control field signals that a PN, a MIC, and a UHR FCS are present in the trigger frame.

14. The non-transitory computer-readable medium of claim 10, wherein the block acknowledgement frame is a multi-station block acknowledgement frame comprising a frame control field, a duration field, a receiver address, a transmitter address, a block acknowledgment control field, a block acknowledgement information field, and an FCS, wherein the block acknowledgement information field comprises a per association identifier (AID) traffic identifier (TID) information field for each AID TID tuple, and wherein the per AID TID information field comprises the padding bits.

15. The non-transitory computer-readable medium of claim 14, wherein the per AID TID information field further comprises a block acknowledgement bitmap comprising a PN and a MIC.

16. The non-transitory computer-readable medium of claim 10, wherein the block acknowledgement request frame is a compressed block acknowledgement request variant or a multi-traffic indicator (multi-TID) block acknowledgement request variant comprising a frame control field, a duration field, a receiver address, a transmitter address, a block acknowledgement request control field, a block acknowledgement request information field, and an FCS, and wherein at least one of the block acknowledgement request control field or the block acknowledgement request information field signals the presence of the padding bits.

17. A method for using padding bits for protecting trigger frames, block acknowledgement request frames, and block acknowledgement frames, the method comprising:
generating, by processing circuitry of a device, padding bits of a trigger frame, a block acknowledgment request frame, or a block acknowledgement frame;
generating, by the processing circuitry, one or more fields signaling that the padding bits are present in the trigger frame, the block acknowledgement request frame, or the block acknowledgement frame; and
causing to send, by the circuitry, the trigger frame, the block acknowledgement request frame, or the block acknowledgement frame to one or more STAs, the trigger frame, the block acknowledgement request frame, or the block acknowledgement frame comprising the one or more fields and the padding bits.

18. The method of claim 17, wherein the trigger frame comprises a special user information field preceding a packet number (PN), a message integrity check (MIC), an ultra high reliability (UHR) frame check sequence (FCS), the padding bits, and an FCS, and wherein the special user information field signals that the padding bits are present.

19. The method of claim 17, wherein the block acknowledgement frame is a multi-station block acknowledgement frame comprising a frame control field, a duration field, a receiver address, a transmitter address, a block acknowledgment control field, a block acknowledgement information field, and an FCS, wherein the block acknowledgement information field comprises a per association identifier (AID) traffic identifier (TID) information field for each AID TID tuple, and wherein the per AID TID information field comprises the padding bits.

20. The method of claim 17, wherein the block acknowledgement request frame is a compressed block acknowledgement request variant or a multi-traffic indicator (multi-TID) block acknowledgement request variant comprising a frame control field, a duration field, a receiver address, a transmitter address, a block acknowledgement request control field, a block acknowledgement request information field, and an FCS, and wherein at least one of the block acknowledgement request control field or the block acknowledgement request information field signals the presence of the padding bits.
